(19) United States
(12) Patent Application Publication
(10) Pub. No.: US 2026/0035496 A1
(43) Pub. Date: Feb. 5, 2026

(54) AQUEOUS PHOTO-INIFERTER POLYMERIZATION OF POLYACRYLONITRILE AND COPOLYMERS THEREOF

(71) Applicants: Tristan Clemons, Hattiesburg, MS (US); Evan Stacy, Hattiesburg, MS (US); Charles McCormick, IV, Hattiesburg, MS (US)

(72) Inventors: Tristan Clemons, Hattiesburg, MS (US); Evan Stacy, Hattiesburg, MS (US); Charles McCormick, IV, Hattiesburg, MS (US)

(73) Assignee: The University of Southern Mississippi, Hattiesburg, MS (US)

(21) Appl. No.: 19/277,733

(22) Filed: Jul. 23, 2025

Related U.S. Application Data
(60) Provisional application No. 63/674,652, filed on Jul. 23, 2024.

(51) Int. Cl. C08F 120/44; C08F 2/38; C08F 2/48; C08F 220/46; C08F 220/48; D01D 5/06; D01D 5/28; D01F 6/18

(52) U.S. Cl. CPC C08F 120/44; C08F 2/38; C08F 2/48; C08F 220/46; C08F 220/48; D01D 5/06; D01D 5/28; D01F 6/18; D10B 2321/10

(57) ABSTRACT

A polyacrylonitrile homopolymer, wherein the homopolymer has a number average molecular weight of from about 50,000 to about 1,000,000 g/mol, as measured by gel permeation chromatography, and a polydispersity index of from about 1.0 to about 1.5. Also disclosed is a method of making a polyacrylonitrile homopolymer, comprising mixing a)-c) to form a mixture:
a) an amount of an acrylonitrile monomer;
b) an amount of a chain transfer agent, and
c) an amount of an aqueous solution comprising one or more components selected from the group consisting of an inorganic salts, organic salts, transition metals, and one or more organic solvents; and
   polymerizing the mixture via photo-iniferter reversible addition-fragmentation chain transfer (PI-RAFT) polymerization.

### CROSS REFERENCE TO RELATED APPLICATIONS

This application claims the benefit of U.S. provisional application No. 63/674,652, filed on Jul. 23, 2024, the disclosure of which is hereby incorporated by reference in its entirety as if fully set forth herein.

### BACKGROUND OF THE INVENTION

Carbon fiber is the structural material of the 21^{st} century, with its high strength to weight ratio making it the material of the future for weight sensitive industries including aerospace, automotive, energy, and construction.¹ Carbon fiber reinforced polymers are the highest performance polymer matrix composites due to the high strength, high modulus, and low density of carbon fibers. Additionally, these composite materials retain high tensile moduli and high strengths at elevated temperatures and in extreme environments, offer excellent electrical and thermal conductivity, and display a relatively low coefficient of thermal expansion.² With these benefits, it is anticipated that the global demand for carbon fiber composites will double over the next 10-years.³ Achieving optimal carbon fiber performance however, hinges on effectively designing precursor polymers and polymer structures.⁴

To date, state-of-the-art carbon fibers have an ultimate tensile strength of approximately 7 GPa and a Young's modulus ranging from 200 GPa to 500 GPa,⁶ which greatly underestimates the theoretical potential of this class of materials.⁷ Improving carbon fiber properties is challenging due to the complexity of carbon fiber production, which involves designing and synthesizing precursor polymers, converting them into white fibers, and ultimately transforming these fibers into carbon fiber.⁷

Carbon fiber produced from polyacrylonitrile (PAN) currently dominates the industry accounting for more than 90% of carbon fiber production.^{1, 5} PAN is well suited to forming high-performance carbon fiber due to its ability to form well-defined graphitic structures through a stepwise carbonization process. It is generally accepted that high molecular weights (>150,000 g-mol⁻¹) of PAN precursor enhances carbon fiber mechanical properties, while narrow polymer dispersity (PDI<1.1) facilitates improved solution viscosity and processing windows for fiber production.^{6, 7} To provide these advantages, recent studies have investigated controlled radical polymerization techniques, such as atom transfer radical polymerization (ATRP),⁸ and reversible addition-fragmentation chain transfer (RAFT) polymerization,^{6, 7, 9-13} for the synthesis of more ideal PAN-based precursor polymers for carbon fiber production. These methods, however, require long reaction times, involve toxic solvents and achieve relatively low conversions. Moreover, PAN polymerizations are difficult to control even at moderate molecular weights, resulting in only a handful of synthetic approaches capable of achieving well-defined PAN with a Mₙ>150,000 g/mol ideal for fiber spinning.^{6, 7, 9, 11, 14} Recent studies have achieved this utilizing aqueous systems,¹⁰ and photo-initiated systems,¹⁵ respectively. High molecular weight results in enhanced mechanical properties of the carbon fiber,¹⁶ while low dispersity allows for improved processability in the fiber spinning process,¹⁷ making both of these targets important for the manufacture of high-performance carbon fiber. Moskowitz and colleagues demonstrated improved control in the RAFT polymerization of high molecular weight PAN (>100,000 g-mol⁻¹) at 30° C. compared to 70° C.¹² This enhancement at lower temperature resulted from reduced side reactions during polymerization and optimized radical exchange between active and dormant states of the RAFT process through proper selection of the RAFT agent and initiator.¹² However, achieving this required reaction times of approximately 48 hours, with best conversions reported at ˜70% (Table 1). A significant concern was the substantial gap between theoretical and experimentally achieved molecular weights, nearly three times higher, indicating that while conversion rates are relatively high, the majority of conversion does not generate high molecular weight polymer. There exists an opportunity to utilize controlled radical polymerization methods for PAN to attain precursor polymers of high molecular weight (>100,000 g-mol⁻¹), low dispersity, and importantly, high polymer yield, thereby enhancing atom efficiency in precursor polymer design.

PAN-based carbon fibers are generally recognized as still “the most important and promising precursors for manufacture of high strength carbon fibers.”⁷ Currently, PAN for carbon fiber uses acrylonitrile (AN), a monomer produced from propylene using the Sohio process at a scale on the order of 6-million tons per year (FIG. 1).⁹

A key challenge for the industrial synthesis of PAN however, is that PAN is not soluble in its own monomer, rendering bulk polymerizations of acrylonitrile infeasible. As a result, free radical polymerization in solution, suspension, or an emulsion is usually employed.¹⁰ PAN is soluble in polar organic solvents such as dimethylformamide (DMF), dimethylsulfoxide (DMSO), and ethylene carbonate (EC), all of which are currently used for PAN synthesis.¹⁵ However, these solvents are toxic, expensive, and exhibit high boiling points, making polymer purification at industrial scales difficult.^{16, 17} Alternatively, concentrated aqueous solutions of particular inorganic salts, such as sodium thiocyanate (NaSCN, 50 wt. %) or zinc chloride (ZnCl₂, 60 wt. %), have been used in carbon fiber processing to dissolve high molecular weight PAN for fiber spinning.¹⁸⁻²⁰ The Matyjaszewski laboratory reported on utilizing these highly salted aqueous solutions for conventional thermal-initiated RAFT polymerization of PAN,¹² but were limited to modest molecular weights (˜60,000 g-mol⁻¹) which are unsuitable for high-performance carbon fiber production.

Table 1 shows a comparison of recent studies investigating the design of poly(acrylonitrile) for carbon fiber production.

TABLE 1

| | Polymerization | Time | Conversion | Mn | | |
|---|---|---|---|---|---|---|
| Polymer | Method | (h) | (%) | (g-mol⁻¹) | PDI | Source |
| PAN | FRP | 8 | — | 20,000 | 3 | Liu et. al.¹⁸ |
| PAN | RAFT | 24 | 60 | 57,000 | 1.4 | Kopec et. al.¹⁰ |
| PAN | FRP | 12 | — | 100,300 | 1.32 | Chen et. al.¹⁹ |
| PAN | RAFT | 24 | 64 | 126,000 | 1.36 | Moskowitz et. al.¹² |
| PAN | ATRP | 7 | 72 | 13,600 | 1.53 | Pan et. al.¹¹ |
| PAN | RAFT | 10 | 56.5 | 218,000 | 1.21 | Li et. al.¹⁵ |
| PAN | RAFT | 48 | 71 | 131,000 | 1.27 | Moskowitz et. al.¹ |
| PAN | FRP | 8 | — | 258,000 | 2.09 | Moskowitz et. al.¹ |
| PAN | RAFT | 48 | 70 | 168,000 | 1.25 | Moskowitz et. al.¹² |

Footnotes: PAN = polyacrylonitrile, FRP = free radical polymerization, RAFT = reversible addition-fragmentation chain transfer polymerization, ATRP = atom transfer radical polymerization.

PAN homopolymer is seldom used for carbon fiber manufacture due to its low solubility and poor processability due to strong interactions and close packing of polymer chains.²⁰ Typically, 3-10 wt. % of various comonomers are copolymerized with acrylonitrile to improve solubility, spinnability, drawability, hydrophilicity, and most importantly, assist in the stabilization of the fibers during pyrolysis.^{14, 19} Comonomers containing nucleophilic pendant groups alleviate the centralized heat release during the thermo-oxidative stabilization step by offering an alternative pathway to cyclization (FIG. 2).²⁰ Obviating this highly exothermic reaction helps mitigate the formation of defects, which results in improvement of the mechanical properties of the carbon fibers.^{19, 20} Additionally, it is common to incorporate neutral, bulky comonomers, such as methyl methacrylate, to improve the plasticity of PAN-based precursors for spinnability and drawability.^{19, 20} The downside is that it is difficult to control comonomer distribution due to the varying monomer reactivities, which can counteract the desired advantages.¹⁴ For example, unequal reactivities could result in a heterogeneous distribution of comonomers along the polymer chain which can result in significant voids developing during the carbonization process, ultimately limiting fiber performance. Review of the recent literature reveals challenges with respect to achieving high molecular weight and low dispersity, at high polymer yields for PAN-based copolymers (Table 2). For example, Sayyar et al. synthesized a high molecular weight (˜150,000 g mol⁻¹) copolymer of PAN-co-NIPAM by RAFT, but required a significant monomer excess, and was limited to only 32% conversion with moderate dispersity control to achieve this.¹⁴ To date a structure-property approach to study the incorporation of comonomers with PAN to support thermo-oxidative stabilization has not been conducted. Given the benefits in fiber spinning and thermo-oxidative stabilization of PAN-based copolymers, there is a substantial opportunity to develop high molecular weight PAN-based copolymers with low dispersity, and high polymer yield, for improving carbon fiber precursor design.

Recent work from the Sumerlin laboratory has demonstrated that aqueous photo-iniferter (PI) RAFT (AqPI-RAFT) polymerization can achieve ultra-high molecular weights (UHMW, Mₙ greater than 1.00×10⁶ g-mol⁻¹) for water-soluble polymers, with narrow dispersities.²⁷ The kinetic conditions of polymerization to achieve UHMW polymers include a high rate of propagation (kₚ) and a low rate of irreversible termination (Kₜ). It has been well documented that an aqueous reaction medium can support high rates of propagation (kₚ).²⁸⁻³⁰ Photo-iniferter RAFT polymerization limits background initiation of low molecular weight chains that lead to irreversible and premature chain termination throughout the polymerization and which are often generated continuously during traditional, exogenously initiated RAFT polymerizations.²⁷ Finally, solution viscosity can play a role in limiting irreversible termination, where higher solution viscosity can reduce chain translational diffusion, and in turn limit bimolecular termination maintaining the pseudo-living character of the polymerization.³¹ A study by Li et. al. explored photo-iniferter polymerization of PAN in ethyl carbonate and was able to achieve high molecular weights, but only at low conversions, resulting in poor atom economy.¹³

Table 2 shows a comparison of recent studies investigating the design of copolymers of poly(acrylonitrile) for carbon fiber production.

TABLE 2

| | Co-mon. | Polymerization | Time | Conversion | Mn | | |
|---|---|---|---|---|---|---|---|
| Polymer | (%) | Method | (h) | (%) | (g-mol⁻¹) | PDI | Source |
| p(AN-co-AMPS) | 4 | FRP | 12 | — | 23,500 | 2.56 | Chen et. al.¹⁹ |
| p(AN-co-MA) | 1.5 | FRP | 12 | — | 123,200 | 2.46 | Chen et. al.¹⁹ |
| p(AN-co-IA) | 5 | FRP | 8 | — | 16,000 | 3.25 | Liu et. al.¹⁸ |
| p(AN-co-NIPAM) | 5 | RAFT | 48 | 64 | 154,700 | 1.40 | Moskowitz et. al.¹ |
| p(AN-co-AA) | 5 | RAFT | 48 | 72 | 197,500 | 1.23 | Moskowitz et. al.¹ |
| p(AN-co-NIPAM) | 3.7 | RAFT | 48 | — | 68,000 | 1.18 | Moskowitz et. al.²¹ |
| p(AN-co-NIPAM) | 2 | RAFT | 48 | 32 | 152,000 | 1.46 | Sayyar et. al.¹⁴ |

Footnotes: AN = acrylonitrile, AA = acrylic acid, NIPAM = N-isopropylacrylamide, AMPS = 2-acryloamido-2-methylpropane sulfonic acid, MA= methyl acrylate, IA = itaconic acid, Co-mon. = comonomer to AN, FRP = free radical polymerization, RAFT = reversible addition-fragmentation chain transfer polymerization.

Controlling polymer tacticity along with molecular weight is an exciting prospect, especially for polymers of acrylonitrile for use in carbon fiber production. It is hypothesized that the cyclization yield and formation of ‘ladder structures’ during carbonization could be improved in highly isotactic polymers of acrylonitrile.²² Recent studies have shown that Lewis acids can enhance isotacticity in radical polymers.²³⁻²⁵ However, achieving high isotacticity in PAN with radical polymerization methods has had limited success.²⁶ Okamoto and colleagues demonstrated that temperature significantly influenced tacticity in the radical polymerization of N-isopropylacrylamide, with 80% meso diads achieved at 60° C. and over 90% at −20° C.²⁵ As a result, the ability to provide low dispersity, high molecular weight, isotactic polymers of acrylonitrile remains an exciting prospect, highly suitable to photo-initiated RAFT polymerizations, which can be conducted at sub-ambient temperatures, in the presence of Lewis acid mediators.

### SUMMARY OF THE INVENTION

The present invention relates to a novel approach that leverages the high rates of propagation achievable in water and the pseudo-living nature of PI-RAFT polymerization. The present invention demonstrates the feasibility of utilizing AqPI-RAFT polymerization in high salt content solutions to polymerize PAN-based polymers for high-performance carbon fiber production (FIG. 4). The present invention demonstrates the impact of polymer molecular weight, dispersity, and comonomer incorporation on polymer thermo-oxidative stabilization, fiber spinning, and ultimately carbon fiber performance. By providing high conversions of PAN-based polymers and achieving precise control over key parameters, the present invention provides significant advancements in carbon fiber manufacturing technology, paving the way for next generation materials with unprecedented strength and versatility.

The present invention demonstrates the potential of highly salted aqueous solutions as the polymerization media for aqPI for its utility in the development of precursor polymer synthesis for carbon fiber production (FIG. 3).

The present invention may be described by the following sentences:
1. In a first aspect, the present invention relates to a polyacrylonitrile homopolymer, wherein the homopolymer has a number average molecular weight of from about 50,000 to about 1,000,000, or from about 100,000 to about 500,000 g/mol, as measured by gel permeation chromatography, and a polydispersity index of from about 1.0 to about 1.5, or from about 1.0 to about 1.2, or from about 1.0 to about 1.17.
2. In a second aspect, the present invention relates to a method of making a polyacrylonitrile homopolymer, comprising mixing a)-c) to form a mixture:
   a) an amount of an acrylonitrile monomer;
   b) an amount of a chain transfer agent, optionally selected from dithioesters, dithiocarbamates, trithiocarbonates, and xanthates, and
   c) an amount of an aqueous solution comprising one or more components selected from the group consisting of an inorganic salts, organic salts, transition metals, and one or more organic solvents; optionally selected from zinc salts and NaSCN, wherein the zinc salt is optionally ZnCl₂; and
      polymerizing the mixture via photo-iniferter reversible addition-fragmentation chain transfer (PI-RAFT) polymerization.
3. The method of sentence 2, wherein the aqueous solution may include one or more inorganic salts selected from the group consisting of zinc salts and NaSCN, or combinations thereof.
4. The method of any one of sentences 2-3, wherein the homopolymer may be polymerized in the mixture having a molar ratio of acrylonitrile monomer to chain transfer agent of from about 500:1 to about 50,000:1, or from about 500:1 to about 30,000:1, or about 4,000:1, or about 9,500:1, or about 25,000:1.
5. The method of any one of sentences 2-4, wherein the homopolymer may be polymerized in the mixture having a molarity of the acrylonitrile monomer (mol) to the mixture (liter) of from about 0.5 mol/L to about 10 mol/L, or from about 1.50 mol/L to about 8 mol/L, or from about 2.0 mol/L to about 5 mol/L.
6. The method of any one of sentences 2-5, wherein the step of polymerizing may be carried out for a period of 1 hour to about 120 hours, or from about 5 hours to about 72 hours, or from about 8 hours to about 48 hours.
7. The method of any one of sentences 2-6, where the aqueous solution may include the inorganic salts, the organic salts, the transition metals, or the one or more organic solvents in an amount of from about 20 wt. % to about 80 wt. %, or from about 40 wt. % to about 70 wt. %, based on a total weight of the aqueous solution.
8. The method of any one of sentences 2-7, wherein the polymerization step may be carried out at a temperature of from about −25° C. to about 80° C., or from about −20° C. to about 50° C., or at about 5° C., or about 10° C., or about 20° C., or about 30° C., or about 40° C.
9. The method of any one of sentences 2-8, wherein the polymerization step includes exposing the mixture to UV light irradiation.
10. The method of any one of sentences 2-9, wherein the chain transfer agent is 4-(((2-carboxyethyl)thio)carbonothioyl)thio)-cyanopentanoic acid (CCPA).
11. In a third aspect, the present invention relates to a polyacrylonitrile homopolymer composition formed by the method of any one of sentences 2-10.
12. In a fourth aspect, the present invention relates to a polymer formed by mixing a)-d) to form a mixture:
   a) an amount of an acrylonitrile monomer;
   b) an amount of a comonomer, wherein the comonomer is nucleophilic and is optionally present at a concentration of from about 0.5 wt. % to about 15 wt. %, or from about 1.0 wt. % to about 10 wt. %, or from about 1.5 wt. % to about 5 wt. % based on a total weight of the polymer;
   c) an amount of a chain transfer agent, optionally selected from dithioesters, dithiocarbamates, trithiocarbonates, and xanthate, and optionally is 4-(((2-carboxyethyl)thio)carbonothioyl)thio)-cyanopentanoic acid (CCPA); and
   d) an amount of an aqueous solution comprising one or more components selected from the group consisting of inorganic salts, organic salts, transition metals, and one or more organic solvents, optionally selected from zinc salts and NaSCN, wherein the zinc salt may be ZnCl₂; and
      polymerizing the mixture by photo-iniferter reversible addition-fragmentation chain transfer (PI-RAFT) polymerization to form the polymer.
13. The polymer of sentence 12, wherein the comonomer is selected from the group consisting of phthalic anhydride vinyl, N-isopropylacrylamide, ethylenesulfonic acid, α-nitryl acrylic acid, α-amino acrylic acid, methyl acrylate, methyl methacrylate, acrylamide, acrylic acid, methacrylic acid, vinyl phosphoric acid, maleic anhydride, methacrylamide, 2-acrylamido-2-methyl-1-propane sulfonic acid, itaconic acid, N-isopropylacrylamide, N-vinyl formamide, N-phenylacrylateamide, N-(acryloyloxy)phthalimide, and 4-vinylphenylboronic acid.
14. In a fifth aspect, the present invention relates to a fiber comprising the polymer of any one of sentences 1 and 12-13.
15. In a sixth aspect, the present invention relates to a method of making the fiber of sentence 14, comprising spinning an aqueous solution comprising the polymer of any one of sentences 1 and 12-13, using a spinning process for forming the fiber, optionally, the spinning process is a process employing a multifilament wet jet spinning line or another spinning process suitable for making acrylic fibers.
16. The method of sentence 15, wherein the aqueous polymer solution has a viscosity of from about 100 Pas to about 1000 Pa·s, at a shear rate of 1 s⁻¹, wherein the aqueous polymer solution comprises 10 wt. %-30 wt. % of the polymer, based on the total weight of the aqueous polymer solution, and the aqueous polymer solution comprises water, an organic polymer solution, a solvent, or combinations thereof all at a spinning temperature of 30-60° C.
17. The method of sentence 16, wherein the organic polymer solution comprises dimethyl sulfoxide (DMSO), dimethylformamide (DMF), dimethylacetamide (DMAc), or ethylene carbonate (EC).
18. The method of sentence 16, wherein the aqueous polymer solution has a viscosity of from about 100 Pa·s to about 200 Pa·s, at a shear rate of 1 s⁻¹, and the aqueous polymer solution comprises 20 wt. % of the polymer, based on the total weight of the aqueous polymer solution all at a spinning temperature of 50° C.
19. The method of sentence 18, wherein the spinning is carried out with a multifilament wet jet spinning line.

### BRIEF DESCRIPTION OF THE DRAWINGS

FIG. 1 shows a prior art reaction scheme of the Sohio process which is used to produce over 6 million tons per year of acrylonitrile from propylene, a key product of the petroleum industry.

FIGS. 2A and 2B show schematic reaction schemes for pyridine ring closing in a thermo-oxidative stabilization of PAN-based polymers.

FIG. 2A shows a radical mediated approach observed solely in PAN homopolymers.

FIG. 2B shows the advantageous ionic pathways possible with the incorporation of a nucleophilic comonomer such as acrylic acid which is achieved at an overall lower temperature relative to the radical process show in FIG. 2A.

FIG. 3A shows a schematic representation of the photo-iniferter polymerization process.

FIG. 3B shows an example reaction mechanism for carrying out the method of the present invention.

FIG. 4 shows an aqueous photo-iniferter RAFT for making enhanced carbon fiber precursor polymer.

FIGS. 5A-5C show proof-of-principle results for AqPI-RAFT for PAN synthesis.

FIG. 5A shows a reaction scheme of acrylonitrile in aqueous ZnCl₂ with a water-soluble RAFT agent under mild UV-light irradiation.

FIG. 5B shows acrylonitrile monomer conversion kinetics at temperatures of 8° C. (blue squares) and 27° C. (red circles) with the linear fit for the 27° C. data provided.

FIG. 5C shows a photograph illustrating the high viscosity of PAN following high conversion with AqPI-RAFT.

FIG. 6A shows acrylonitrile monomer conversion kinetics while undergoing constant illumination of UV light at 27° C. in 60 wt. % ZnCl₂ (represented by circles), in 50 wt. % NaSCN (represented by squares), in ethylene carbonate (represented by diamonds), and in dimethyl sulfoxide (represented by triangles). Data is displayed as mean±standard deviation, n=3 per time point.

FIG. 6B shows monomer conversion kinetics while undergoing interrupted illumination at 27° C. in 60 wt. % ZnCl₂ (aq) as solvent.

FIG. 6C shows theoretical molecular weights (represented by the dashed line), experimental molecular weights (represented by triangles), and polydispersity's (represented by squares) of the reaction kinetics as a function of monomer conversion. M_{n,th}=[M]₀/[CCPA]₀×MW_{M}×p+MW_{CCPA}, where [M]₀, [CCPA]₀, MW_{M}, p, and MW_{CCPA} represent initial monomer concentration, initial CCPA concentration, molar mass of the monomer, conversion, and molar mass of CCPA, respectively.

FIG. 6D shows representative gel permeation chromatography (GPC) profiles of the purified polymer at several different reaction times using polymerization at 27° C. with 60 wt. % ZnCl_{2(aq)} as solvent.

FIG. 7A shows GPC traces of high molecular weight PAN prepared by aqPI polymerization undergoing constant illumination of UV light for 24 hours, at 27° C. in 60 wt. % ZnCl₂ or DMSO as the solvent with a target degree of polymerization (DP) identified in the Figure.

FIG. 7B shows a photograph illustrating PAN DP 9.5k after 12 hours of polymerization, demonstrating the high viscosity achieved during polymerization.

FIG. 7C shows the results of the polymerization kinetics of acrylonitrile at 27° C. in 60 wt. % ZnCl₂ using PAN DP 4,000 as a macroCTA.

FIG. 7D shows GPC traces of PAN DP 1,000 macroCTA and chain extended poly(AN-b-AN) DP 5,000.

FIG. 8 shows a schematic representation of UV light catalyzed photolysis of aqueous thiocyanate to form radical anions. Step (1) includes UV irradiation of aqueous thiocyanate to form a radical anion complex with water. Step (2) is the formation of a weak charge transfer complex between AN and SCN radical anions which facilitates electron transfer and carbon-centered radical generation on monomers. Step (3) is electron transfer induced rearrangement of acrylonitrile monomer and is followed by step (4), which is the bimolecular coupling of carbon centered radicals which results in dimers.

FIGS. 9A-9B show comonomers of the present invention for incorporation with PAN to support reaction mechanisms for closing rings and thermo-oxidative stabilization.

FIG. 9A shows a reaction schematic for phthalimide based acrylate monomer synthetic protocol

FIG. 9B shows suitable comonomers that can be employed in the present invention.

FIG. 10A is a table showing an experimental determination of monomer conversion, copolymer composition, molecular weight, and activation energy of cyclization for PAN-co-NIPAm samples synthesized by batch and semi-batch photoiniferter polymerization.

FIG. 10B shows Ozawa plots for batch and semi-batch copolymers.

FIG. 10C shows differential scanning calorimetry (DSC) curves for batch and semi-batch copolymers with a 5° C./min ramp rate.

FIG. 11A shows a thermogram chart of PAN homopolymers (aqPI/FRP), PAN-co-NIPAm (aqPI), and PAN-IA-MA (aqPI) carried out at 5° C. per minute.

FIG. 11B shows an ionic cyclization reaction mechanism introduced through carboxylic acid functionalized CTA.

FIG. 12 shows NMR spectra of acrylonitrile (AN) conversion in aqPI RAFT. The NMR spectra is from an aqPI RAFT polymerization of AN in 60 wt. % ZnCl₂ at t=0, 2, 4, 6, and 8 hours.

FIGS. 13A-13C show UV-Vis absorption spectra of polymerizations conducted in 60 wt. % zinc chloride over 24 hours.

FIG. 13A shows the results from frequency sweep experiments for a PAN homopolymer.

FIG. 13B shows the results from frequency sweep experiments for a PAN-IA-MA polymer.

FIG. 13C shows the results from frequency sweep experiments for a PAN-co-NIPAm polymer.

FIG. 14 shows a kinetic plot of polymerizations conducted at 8° C. and 27° C. in aqueous zinc chloride and sodium thiocyanate.

FIG. 15A shows a representative ¹³C NMR spectra of polyacrylonitrile DP 500 synthesized in 60 wt. % ZnCl₂ at 27° C.

FIG. 15B shows a representative ¹³C NMR spectra of polyacrylonitrile DP 500 synthesized in 60 wt % ZnCl₂ at 8° C.

FIG. 16 shows a kinetics study of polyacrylonitrile DP 500 synthesized in 50 wt. % NaSCN at 8° C. and 27° C. Despite conversion of monomer at earlier stages of the reaction, characteristic polymer backbone proton peaks did not appear in the samples polymerized at the sub ambient 8° C. temperature.

FIG. 17 shows ¹H NMR spectra of a reaction between sodium thiocyanate and acrylonitrile monomer following 4 hours of ultra-violet light irradiation.

FIG. 18 shows ¹³C NMR spectra of acrylonitrile, sodium thiocyanate, and initial and final timepoints of the reaction.

FIG. 19 shows polymerization kinetics of acrylonitrile DP 2000 with aliquots taken for GPC analysis to confirm agreement between theoretical and experimental Mn.

FIG. 20 shows a cost analysis for various industrially relevant solvents for processing of carbon fiber precursors.

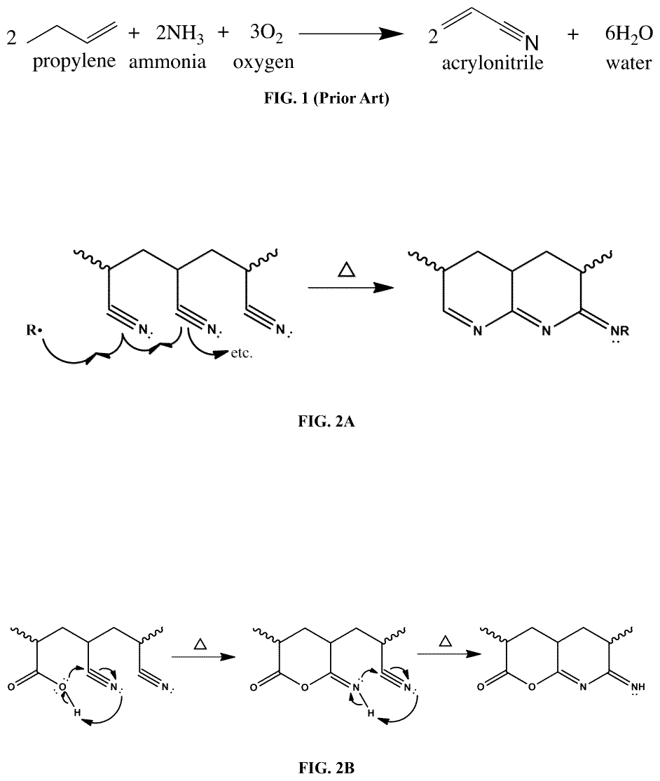

### DETAILED DESCRIPTION OF THE INVENTION

The present invention relates to polyacrylonitrile homopolymer having an average molecular weight of from about 50,000 g/mol to about 1,000,000 g/mol, or from about 100,000 g/mol to about 1,000,000 g/mol, or from about 100,000 to about 500,000, with a low polydispersity index of from about 1.0-1.5, or from about 1.0 to about 1.2, and methods of preparing the polyacrylonitrile. The present invention also relates to carbon fiber precursors formed by reacting acrylonitrile (AN) with comonomer(s) to create copolymers containing AN at high percentages (greater than 75 wt. % AN). The polymers of the present invention may be prepared using aqueous photo-iniferter—reversible addition-fragmentation chain transfer polymerization (AqPI-RAFT).

The polyacrylonitrile homopolymer disclosed herein may be prepared by mixing components a)-c) to form a mixture:
a) an amount of an acrylonitrile monomer;
b) an amount of a chain transfer agent, optionally selected from dithioesters, dithiocarbamates, trithiocarbonates, and xanthates, and
c) an amount of an aqueous solution comprising one or more components selected from the group consisting of an inorganic salts, organic salts, transition metals, and one or more organic solvents; optionally, the inorganic salt is selected from zinc salts and NaSCN, wherein the zinc salt is optionally ZnCl₂; and
   polymerizing the mixture via photo-iniferter reversible addition-fragmentation chain transfer (PI-RAFT) polymerization.

The aqueous solution may include one or more components selected from inorganic salts, for example, sodium acetate, ammonium acetate, tetrabutylammonium acetate, zinc salts and NaSCN, or combinations thereof; organic salts, for example, wherein the organic salts comprise an anion and cation, wherein the cation is selected from the group consisting of Zn²⁺, Fe³⁺, Fe²⁺, Cu²⁺, Cu⁺, Cr³⁺, Cr²⁺, Mn²⁺, Mn³⁺, CO³⁺, Ni²⁺, Ni³⁺, Sn²⁺, Sn⁴⁺, Pb²⁺, and Pb⁴⁺ ions, and wherein the anion is selected from the group consisting of acetate (CH₃COO—), formate (HCOO—), propionate (C₂H₅COO—), octoate, ethanedioate ([C₂O₄]²⁻), and organic sulphonic acid ions; transition metals such as scandium, titanium, vanadium, chromium, manganese, iron, cobalt, nickel, copper, and zinc; or organic solvents which may include ethylene carbonate (EC), dimethylacetamide (DMAc), dimethylformamide (DMF), and dimethylsulfoxide (DMSO). The aqueous solution may include the one or more components selected from the group consisting of an inorganic salts, organic salts, transition metals, and one or more organic solvents in an amount of from about 30 wt. % to about 80 wt. %, or from about 40 wt. % to about 70 wt. %, based on a total weight of the aqueous solution.

The homopolymer is polymerized in the mixture having a molar ratio of acrylonitrile monomer to chain transfer agent of from about 500:1 to about 50,000:1, or from about 500:1 to about 30,000:1, or about 4,000:1, or about 9,500:1, or about 25,000:1. The homopolymer is polymerized in the mixture having a molarity of the acrylonitrile monomer (mol) in the mixture (liter) of from about 1 mol/L to about 10 mol/L, or from about 1.50 mol/L to about 8 mol/L, or from about 2.0 mol/L to about 5 mol/L. The polymerization step is carried out for a period of 1 hour to about 120 hours, or from about 5 hours to about 72 hours, or from about 8 hours to about 48 hours. The polymerization step is carried out at a temperature of from about-25° C. to about 60° C., or from about-20° C. to about 50° C., or at about 5° C., or at about 10° C., or at about 20° C., or at about 30° C., or at about 40° C. The polymerization step includes exposing the mixture to UV light irradiation.

The homopolymer is prepared using a chain transfer agent. Suitable examples of chain transfer agents include dithioesters, dithiocarbamates, trithiocarbonates, and xanthates, optionally, the chain transfer agent is 4-(((2-carboxyethyl)thio)carbonothioyl)thio)-cyanopentanoic acid (CCPA).

The present invention also relates to polymers which may be formed by mixing a)-d) to form a mixture:
c) an amount of an acrylonitrile monomer;
d) an amount of a comonomer, wherein the comonomer is nucleophilic and is optionally present at a concentration of from about 0.5 wt. % to about 10 wt. %, or from about 1.0 wt. % to about 5.0 wt. %, based on a total weight of the polymer;
c) an amount of a chain transfer agent, optionally selected from dithioesters, dithiocarbamates, trithiocarbonates, and xanthate, and optionally is 4-(((2-carboxyethyl)thio)carbonothioyl)thio)-cyanopentanoic acid (CCPA); and
d) an amount of an aqueous solution comprising one or more components selected from the group consisting of inorganic salts, organic salts, transition metals, and one or more organic solvents, optionally selected from zinc salts and NaSCN, wherein the zinc salt may be ZnCl₂; and
   polymerizing the mixture by photo-iniferter reversible addition-fragmentation chain transfer (PI-RAFT) polymerization to form the polymer.

Suitable examples of comonomer may be selected from the group consisting of phthalic anhydride vinyl, N-isopropylacrylamide, ethylenesulfonic acid, α-nitryl acrylic acid, α-amino acrylic acid, methyl acrylate, methyl methacrylate, acrylamide, acrylic acid, methacrylic acid, vinyl phosphoric acid, methacrylamide, 2-acrylamido-2-methyl-1-propane sulfonic acid, itaconic acid, N-isopropylacrylamide, N-vinyl formamide, N-phenylacrylateamide, N-(acryloyloxy)phthalimide, and 4-vinylphenylboronic acid.

In another aspect, the present invention relates to fibers including the polymer described herein. The fibers may be prepared by spinning an aqueous solution comprising the polymers disclosed herein, using a spinning process for forming the fiber, optionally, the spinning process is a multifilament wet jet spinning line or other spinning processes suitable for making acrylic fibers.

When forming the fibers, the aqueous polymer solution has a viscosity of from about 100 Pa·s to about 300 Pa·s, at a shear rate of 1 s⁻¹, wherein the aqueous polymer solution comprises 10 wt. %-30 wt. % of the polymer, based on the total weight of the aqueous polymer solution, at a spinning temperature of 30-60° C., wherein the aqueous polymer solution comprises water, an organic polymer solution, a solvent, or combinations thereof. The organic polymer solution may include comprises dimethyl sulfoxide (DMSO), dimethylformamide (DMF), and ethylene carbonate (EC). The aqueous polymer solution may have a viscosity of from about 100 Pa·s to about 200 Pa·s, at a shear rate of 1 s⁻¹, wherein the aqueous polymer solution comprises 20 wt. % of the polymer, based on the total weight of the aqueous polymer solution at a spinning temperature of 50° C.

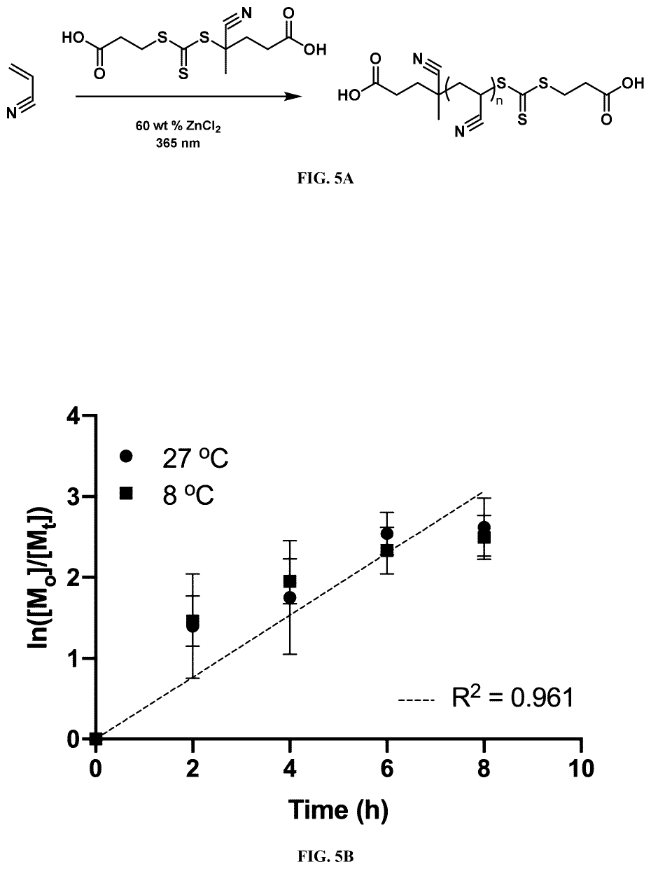

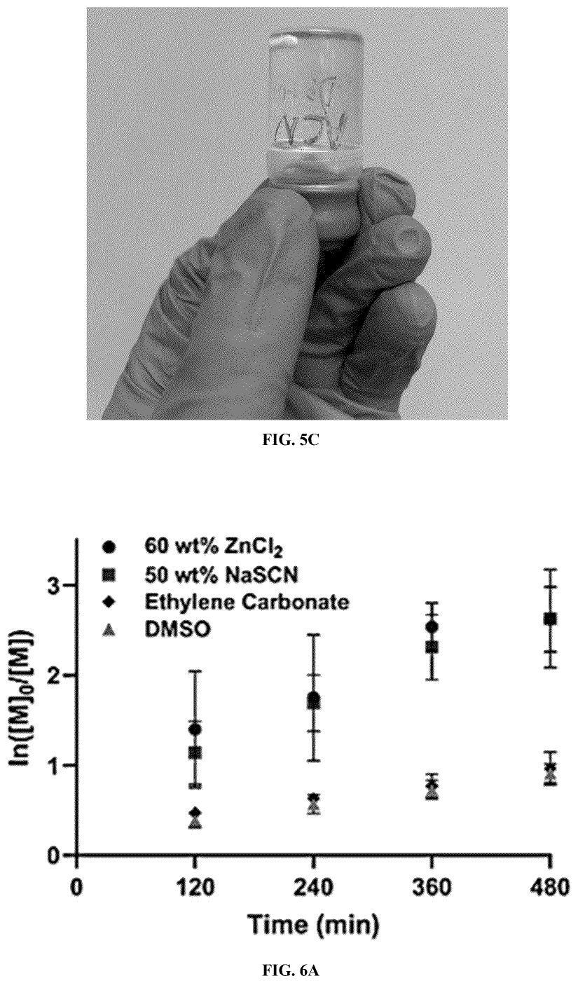

In the working examples, the kinetics, and control of important polymer properties including molecular weight, dispersity, and tacticity were demonstrated. For example, ultraviolet (UV) light AqPI-RAFT was implemented on acrylonitrile with 4-((((2-carboxyethyl)thio)carbonothioyl)thio)-4-cyanopentanoic acid, as the water-soluble chain transfer agent (CTA), and 60 wt. % aqueous ZnCl2 as the solvent (FIG. 5A). Pseudo-first order kinetics of monomer conversion were evident at both ambient and reduced temperatures (FIG. 5B), while targeting a high molecular weight PAN achieved high conversion in only 8 hours, significantly faster than has been reported in current literature (FIG. 5C).

Due to the high salt concentration, these aqueous PAN solutions of the present invention exhibited a significant depression in freezing point, enabling low temperature polymerization down to −30° C. while remaining liquid. Prior research has shown improved control of PAN polymerization by lowering the temperature from 70° C. to 30° C.¹² Additionally, studies have highlighted enhanced polymer isotacticity through radical polymerization at −20° C.²⁵ ZnCl₂ and NaSCN were employed as solubilizing agents for PAN processing,³⁵⁻³⁷ while copper (II) perchlorate and zinc (II) perchlorate have demonstrated excellent Lewis acid catalytic stability in aqueous systems,³⁸ presenting as exciting economical candidates for imparting tacticity control to PAN.^{26, 39}

Conversion of monomer during the polymerization was studied with proton nuclear magnetic resonance (¹H NMR) spectroscopy to determine reaction kinetics. Molecular weight and dispersity were assessed with size exclusion chromatography (SEC) using multi-angle laser light scattering (MALLS) detection. Polymer chain end fidelity was analyzed using a combination of UV-visible spectroscopy, ¹H NMR, and chain extension experiments were conducted on purified polymer. Finally, tacticity was assessed by ¹³C NMR calculating relative amounts of meso-meso (mm), meso-racemo (mr), and racemo-racemo (rr) triads as described previously.¹⁰ The examples set forth herein demonstrated that AqPI-RAFT is capable of synthesizing high molecular weight PAN (Mₙ>100,000 g-mol⁻¹), with rapid kinetics, and control (PDI<1.2).

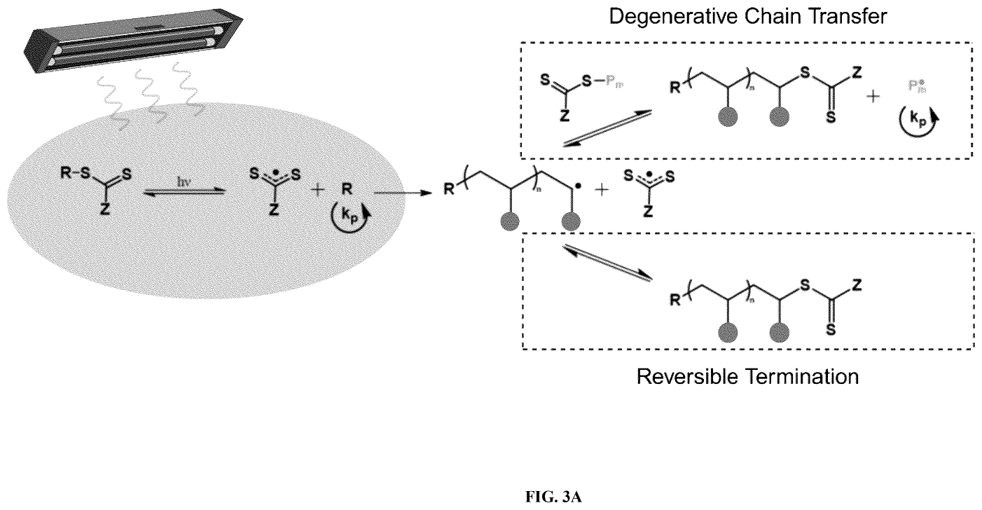

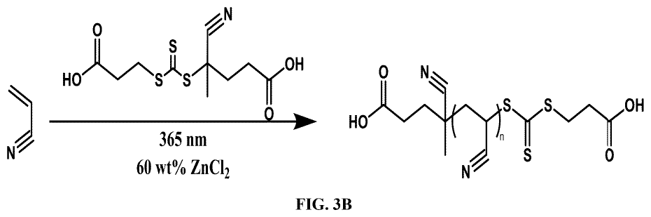

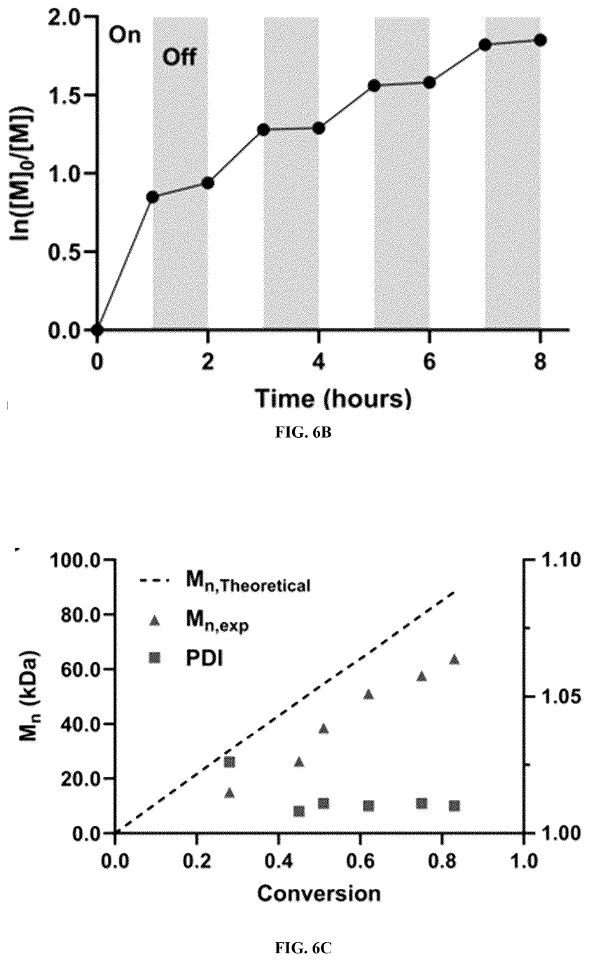

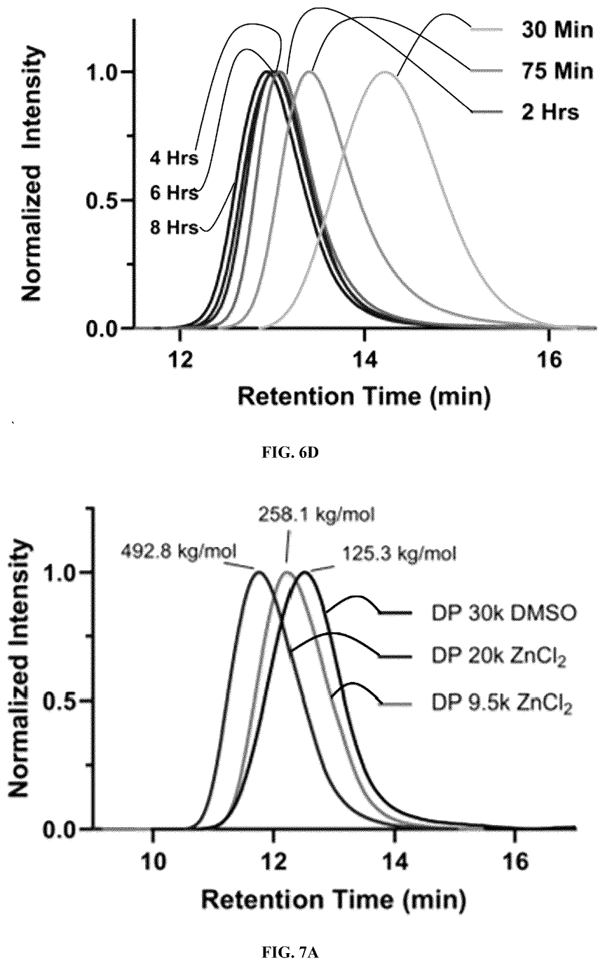

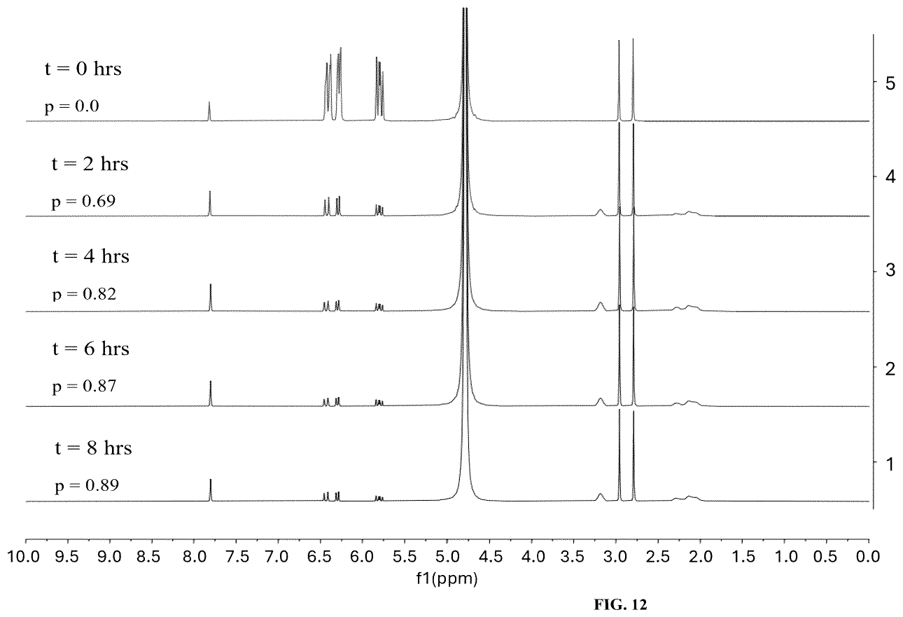

For the aqPI-RAFT polymerization of acrylonitrile, 4-((((2-carboxyethyl)thio)carbonothioyl)thio)-4-cyanopentanoic acid (CCPA) was selected as the chain transfer agent (CTA) due to its two hydrophilic carboxyl groups leading to enhanced solubility in the aqueous reaction media (FIG. 3B). The nitrile units of the R group were chosen to enhance the rate of initiation, generating radicals stable enough to favorably cleave upon irradiation while still active enough to initiate polymerization. Moreover, both addition to CCPA (k_{add}) and β-scission (k_{β}) can occur at appreciable rates to facilitate chain transfer throughout the photo-iniferter process. To assess the utility of aqPI-RAFT for PAN an AN/CCPA ratio of 500:1 was initially targeted, and polymerization kinetics were assessed in an aqueous solution of ZnCl₂ (60 wt. %). The reaction yielded 90% conversion of AN following 8 hours of illumination, as determined from ¹H NMR (See FIG. 12), and followed pseudo-first order kinetics, with an apparent propagation rate constant of 0.38 h⁻¹ (FIG. 6A). Additionally, 50 wt. % NaSCN was confirmed as a suitable aqueous polymerization media for AN, with a similar kinetic profile to the ZnCl₂ solution yielding an apparent rate constant of 0.37 h⁻¹ (FIG. 6A).

For comparison, the photo-iniferter RAFT polymerization of AN in ethyl carbonate or dimethylsulfoxide (DMSO), both common solvents traditionally used for PAN synthesis,^{7, 9, 13, 14, 25} resulted in significantly slower apparent rates of propagation of approximately 0.12 h⁻¹ for DMSO and 0.13 h⁻¹ for ethyl carbonate (FIG. 6A). This enhanced rate of propagation is consistent with previous work that also observed that aqueous reaction media can support high propagation rates (kₚ).²²⁻²⁴

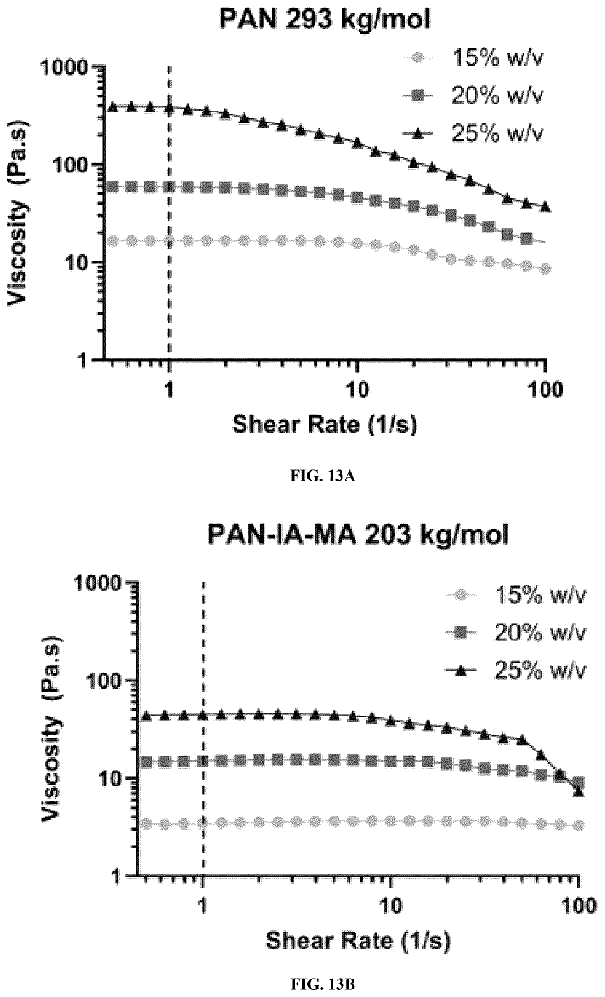

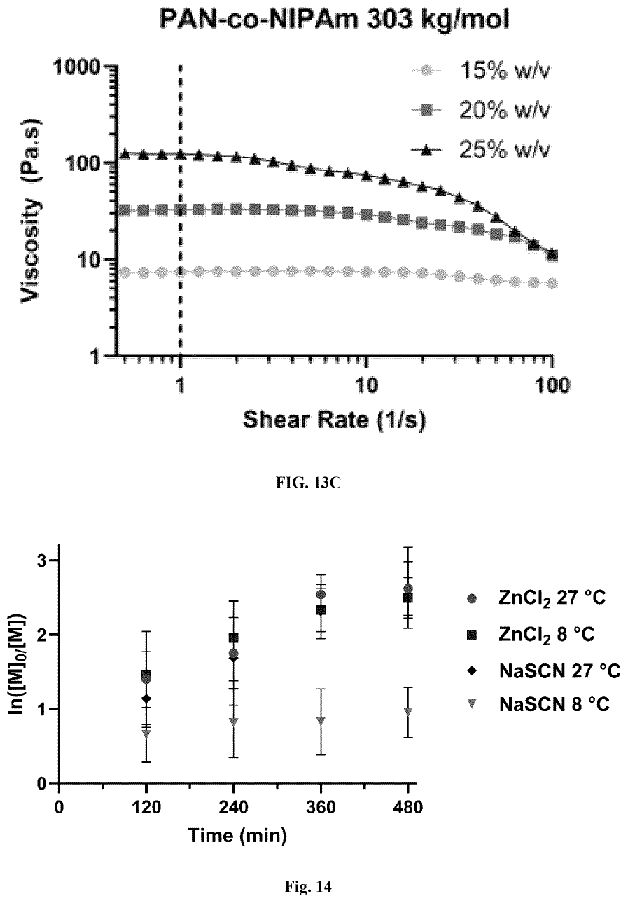

The near-linear pseudo-first-order kinetic plots indicate a relatively constant radical concentration was achieved during the photo-iniferter process up to high conversions of monomer, suggesting that a high degree of chain-end fidelity was maintained throughout the polymerization. Irreversible decomposition of the thiocarbonylthio end group decreased radical concentration, reducing the rate of polymerization and produced a negative deviation in the pseudo-first-order kinetic plot.²¹ To further support this point, the characteristic absorption of CCPA was investigated at 315 nm by UV-Vis spectroscopy. No decrease in absorption was observed at 315 nm after 24 hours of irradiation at 365 nm, indicating that CCPA resisted degradation under the conditions used to perform PAN polymerization (FIG. 13). Photoinitiation allowed for temporal control of the polymerization where switching the light source OFF or ON resulted in reversible deactivation or reactivation of the polymerization. Negligible monomer conversion during the period of no irradiation (i.e. “OFF”) demonstrated the fast deactivation of the polymerization, in agreement with other photo-iniferter processes.²⁶ Finally, a strong agreement was observed between theoretical molecular weights (M_{n,th}) and those observed experimentally by both gel permeation chromatography (GPC, M_{n,GPC}) and nuclear magnetic resonance (NMR, M_{n,NMR}) analysis, respectively (FIG. 6C and Table 1). The linear increase in Mn with monomer conversion, coupled with narrow molecular weight distributions (M_{w}/Mₙ) of the resulting polymer, and the symmetrical GPC traces all indicated control of the polymerization process.

Table 4 shows the results of aqPI polymerization of AN conducted in this study at ambient temperatures.

TABLE 4

| | | | [AN]₀ | Time | Conv.^{a} | M_{n, th}^{b} | M_{n, NMR}^{c} | M_{n, GPC}^{d} | M_{w}/Mₙ |
|---|---|---|---|---|---|---|---|---|---|
| EX | [AN]₀:[CCPA]₀ | Solvent | (mol/L) | (h) | (%) | (g/mol) | (g/mol) | (g/mol) | (g/mol) |
| 1 | 500:1 | 60 wt % ZnCl₂ | 6.25 | 8 | 89 | 24,262 | 23,861 | 29,700 | 1.02 |
| 2 | 500:1 | 50 wt % NaSCN | 6.25 | 8 | 99 | 25,614 | 30,043 | 15,300 | 1.04 |
| 3 | 500:1 | EC | 6.25 | 8 | 66 | 17,812 | 17,002 | 12,500 | 1.05 |
| 4 | 500:1 | DMSO | 6.25 | 8 | 60 | 16,173 | 18,067 | 15,100 | 1.07 |
| 5 | 4000:1 | 60 wt % ZnCl₂ | 2.00 | 18 | 89 | 189,950 | 149,406 | 146,300 | 1.02 |
| 6 | 9,500:1 | 60 wt % ZnCl₂ | 2.00 | 18 | 86 | 433,367 | — | 258,100 | 1.05 |
| 7 | 20,000:1 | 60 wt % ZnCl₂ | 2.00 | 18 | 77 | 812,159 | — | 492,800 | 1.07 |
| 8 | 25,000:1 | 60 wt % ZnCl₂ | 1.50 | 24 | 81 | 1,072,249 | — | 473,500 | 1.16 |
| 9 | PAN-b-PAN | 60 wt % ZnCl₂ | 2.00 | 24 | 82 | 287,239 | — | 238,500 | 1.13 |
| | 8,000:1 | | | | | | | | |

Footnotes: Abbreviations: acrylonitrile (AN), 4-((((2-carboxyethyl)thio)carbonothioyl)thio)-cyanopentanoic acid (CCPA), ethylene carbonate (EC), dimethyl sulfoxide (DMSO).
^{a}Monomer conversion was quantified through ¹H NMR.
^{b}Calculated according to M_{n, th} = ([AN]₀ × conversion × MW_{AN})/[CCPA]₀ + MW_{CCPA}.
^{c}M_{n, NMR} calculated by ¹H NMR on purified polymer comparing proton signals of CCPA end group relative to the proton adjacent to the nitrile in the polymer backbone.
^{d}Molecular weight measured by Gel Permeation Chromatography Multi-Angle Laser Light Scattering (GPC-MALLS) using DMAc with 0.5M LiCl as eluent.

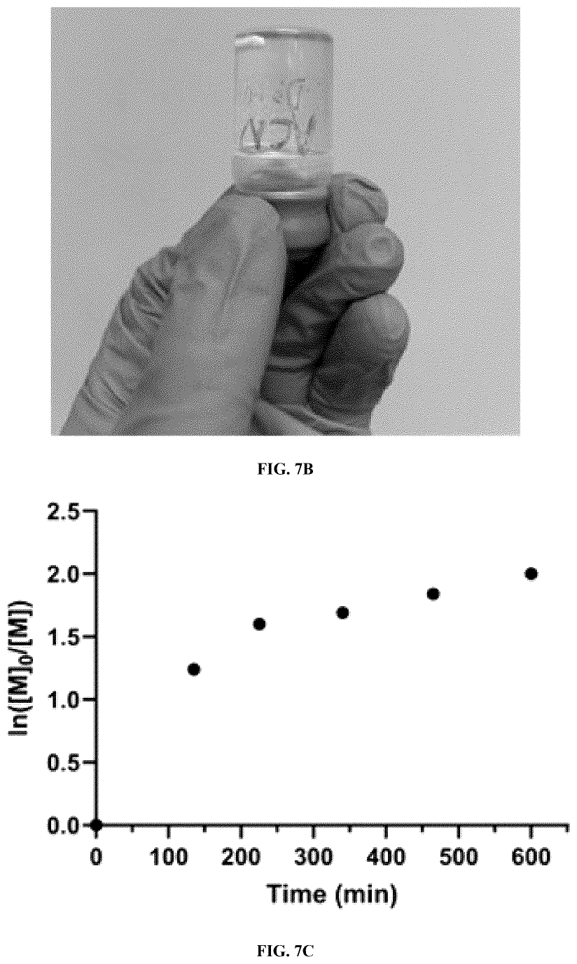

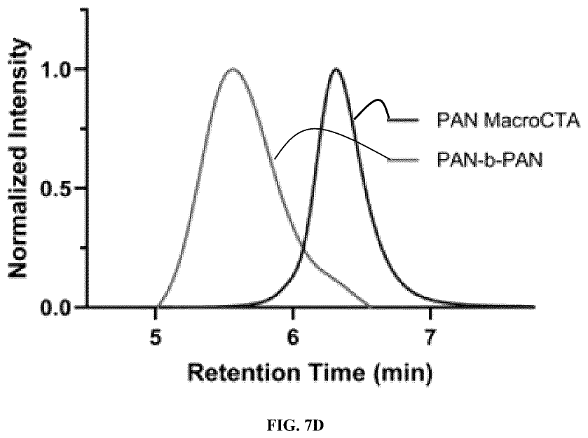

Next, the capacity of aqPI-RAFT to create high molecular weight PAN optimal for carbon fiber production (Table 1) was determined. The accelerated kinetics and low exogenous radical concentrations of photo-iniferter reactions compared to traditional RAFT polymerization enabled photo-iniferter polymerization methods to routinely achieve UHMW polymer.^{21, 27-29} As a result, the aqPI conditions synthesized ultra-high molecular weight (UHMW) PAN (M_{w}>1×10⁶ g/mol). (Entry 8 and 9, Table 4 and FIG. 7A). Importantly this was achieved at high monomer conversion and the strong agreement between theoretical and experimental molecular weights supports control and high yield of the polymer product, a challenge observed in previous studies investigating PAN synthesis by RAFT.

As a further demonstration of high chain end fidelity, the present invention was able to polymerize block copolymers of poly(AN-b-AN) with pseudo-linear first order kinetics (FIG. 7B), and a uniform shift in molecular weight as demonstrated by GPC to indicate chain extension (FIG. 7C). The samples reached a high level of viscosity during the polymerization while maintaining control, again providing further evidence that the high molecular weights were achieved (FIG. 7D).

An advantage of the photo initiation for RAFT is the ability to conduct polymerizations at sub-ambient temperatures. It is hypothesized that the cyclization yield and formation of ‘ladder structures’ during carbonization could be improved in highly isotactic polymers of acrylonitrile.³⁰ Recent studies have shown that Lewis acids can enhance isotacticity in radical polymerizations.³¹⁻³³ However, achieving high isotacticity in PAN with solution polymerization methods has had limited success.³⁴ Okamoto and colleagues demonstrated that temperature significantly influenced tacticity in the radical polymerization of N-isopropylacrylamide, with 80% meso diads achieved at 60° C. and over 90% at −20° C.³³ Thus, it is expected that aqPI, performed at sub-ambient temperatures and in the presence of Lewis acid additives could enhance tacticity control.

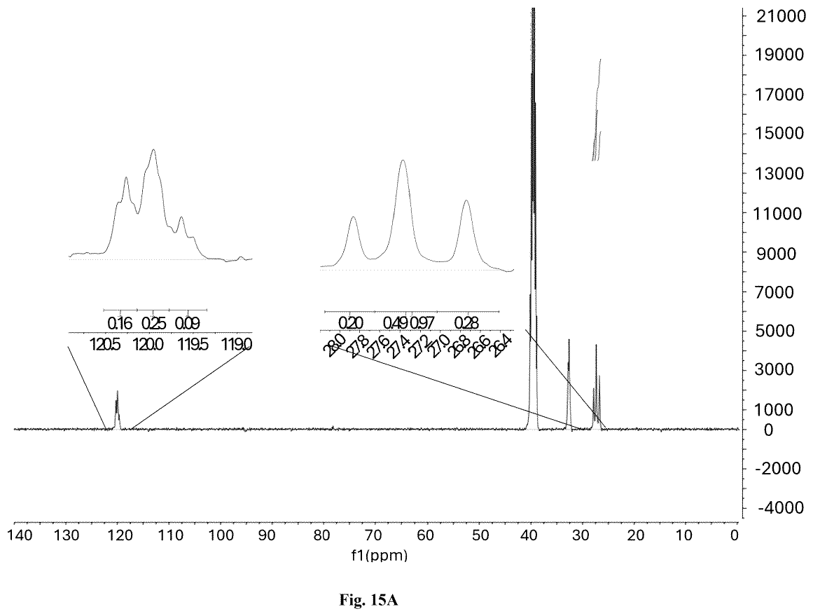

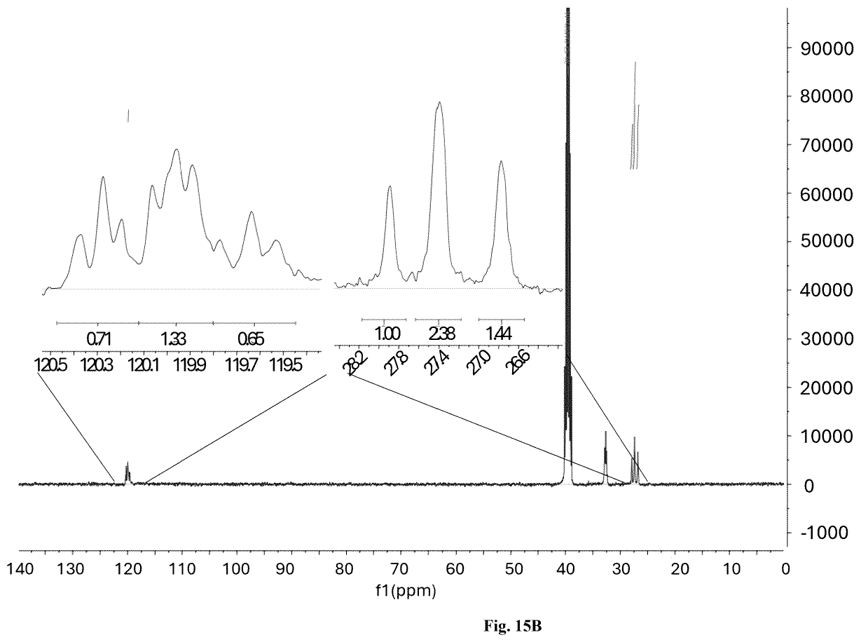

Initially, the impact of polymerization kinetics was assessed at 8° C. versus 27° C. (i.e. ambient temperature). A high conversion of monomer was observed at sub-ambient temperature, achieving greater than 85% conversion in 8 hours of illumination, consistent with observations at ambient temperature (FIG. 14). Next, the impact on polymer tacticity was assessed by ¹³C NMR calculating relative amounts of meso-meso (mm), meso-racemo (mr), and racemo-racemo (rr) triads as described previously (FIG. 15A & 15B),¹² comparing the polymerizations at 8° C. versus 27° C. It was determined that the lower temperature had no significant impact on the tacticity of PAN produced via aqPI in 60 wt. % zinc chloride or 50 wt. % sodium thiocyanate compared to PAN synthesized in traditional organic solvents (Table 5). Additionally, zinc perchlorate was compared due to its demonstrated ability to maintain Lewis acid activity in water.³⁵ However despite the reduced temperature and presence of these known Lewis acids no appreciable difference in tacticity was observed (Table 5). Table 5 shows the influence of Lewis Acid and reaction temperature on PAN tacticity.

TABLE 5

| | Temp. | | C≡N fraction of triads | | | C—H fraction of triads | | |
|---|---|---|---|---|---|---|---|---|
| Solvent | (° C.) | Sample | mm | mr | rr | mm | mr | rr |
| 60 wt % ZnCl₂ | 28 | aqPI (Mₙ = 23,861) | 0.33 | 0.50 | 0.17 | 0.29 | 0.50 | 0.21 |
| 60 wt % ZnCl₂ | 8 | aqPI (Mₙ = 18,659) | 0.26 | 0.50 | 0.24 | 0.30 | 0.49 | 0.21 |
| 50 wt % NaSCN | 28 | aqPI (Mₙ = 30,043) | 0.29 | 0.48 | 0.23 | 0.29 | 0.52 | 0.19 |
| 50 wt % NaSCN | 8 | aqPI (Mₙ, N/A) | — | — | — | — | — | — |
| 50 wt % Zn(ClO₄)₂ | 28 | aqPI (Mₙ = 7,455) | 0.33 | 0.47 | 0.20 | 0.29 | 0.51 | 0.20 |
| 50 wt % Zn(ClO₄)₂ | 8 | aqPI (Mₙ = 7,422) | 0.30 | 0.51 | 0.19 | 0.29 | 0.50 | 0.21 |
| EC | 28 | PI (Mₙ = 17,002) | 0.28 | 0.50 | 0.22 | 0.27 | 0.51 | 0.22 |
| DMSO | 28 | PI (Mₙ = 18,067) | 0.26 | 0.49 | 0.25 | 0.27 | 0.51 | 0.22 |

Footnotes: Abbreviations: Aqueous (aq), photo iniferter (PI) polymerization, ethylene carbonate (EC), dimethyl sulfoxide (DMSO).

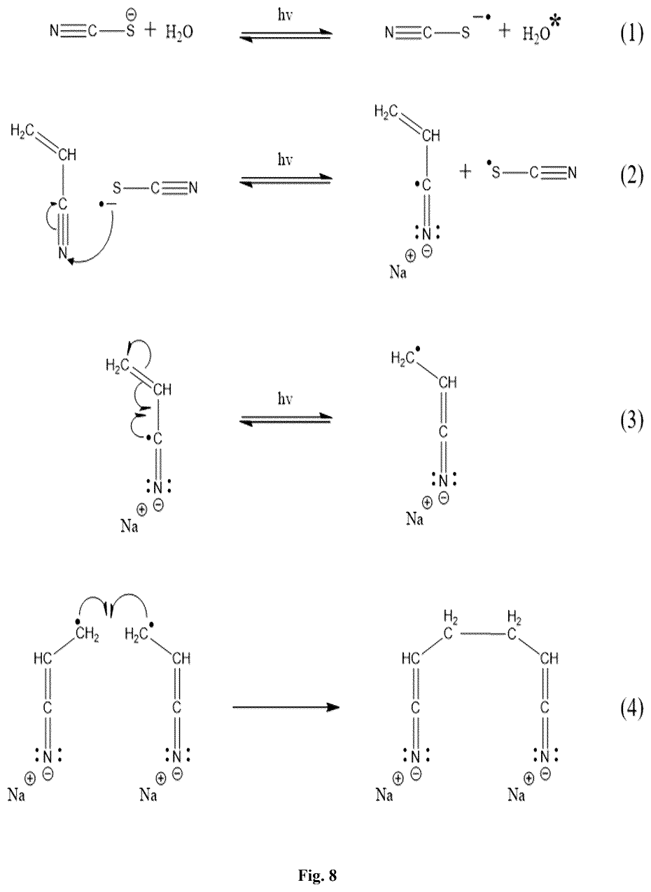

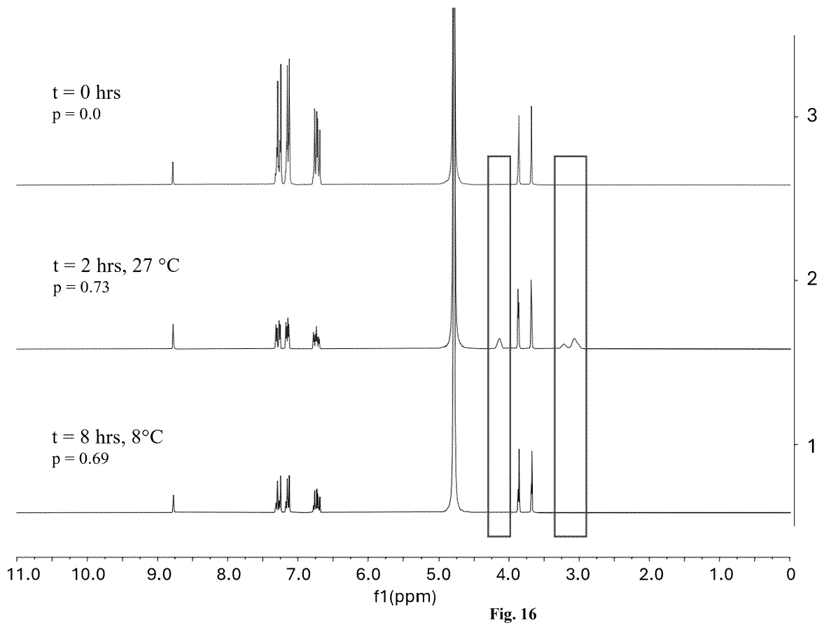

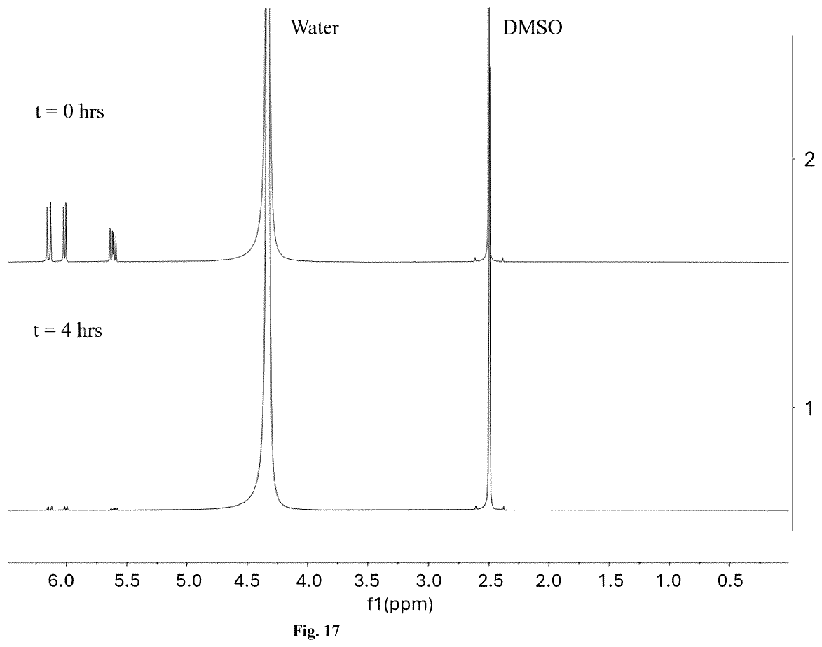

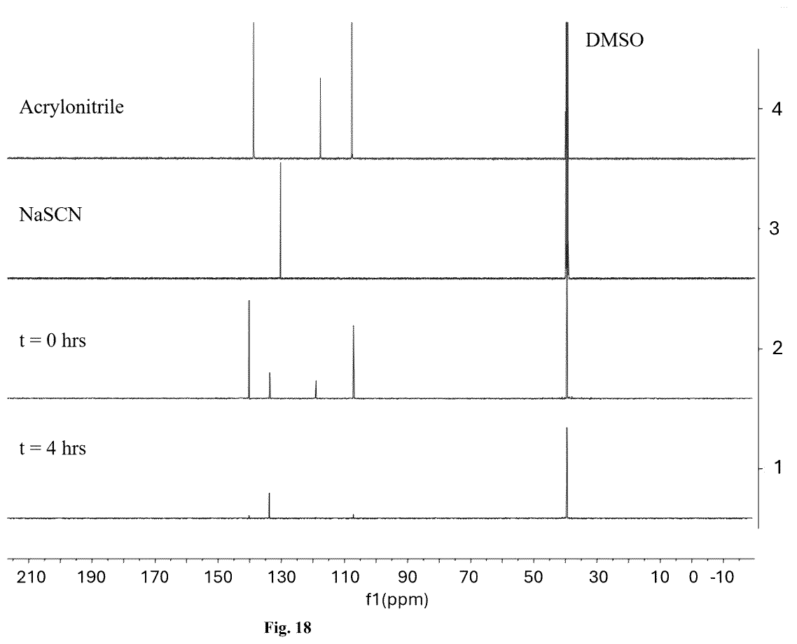

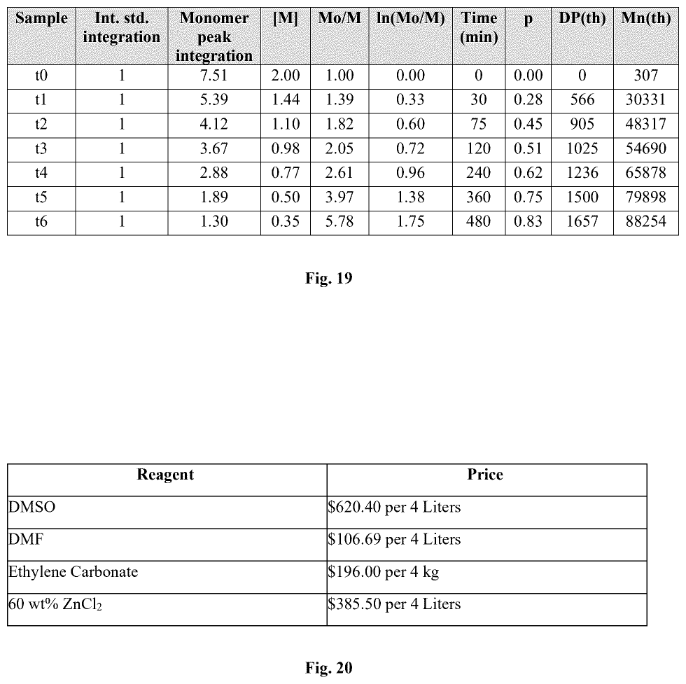

Interestingly, the reactions conducted at 8° C. in aqueous NaSCN never achieved conversions higher than 70% following 8 hours of UV-light exposure. These reactions also failed to produce meaningful quantities of polymer while consuming a significant portion of the available monomer. It was observed that the evolution of broad, polymeric peaks in the proton NMR spectra (FIG. 16) did not occur until later timepoints despite the consumption of vinyl protons early in the reaction. Without being bound to theory, the inventors hypothesized that there may be a competing reaction occurring between thiocyanate ions and the acrylonitrile monomer. UV light has been shown to trigger homolytic cleavage of thiocyanogen into thiocyanato radicals that can rapidly react with mono-and di-substituted alkenes to form α,β-dithiocyanates and allylic isothiocyanates at high yields.³⁶ Similarly, aqueous solutions of thiocyanate anions can undergo photolysis to form thiocyanate radical anions capable of electron transfer rearrangements.^{37, 38} Control experiments conducted in the absence of CTA revealed that vinyl peak consumption occurred rapidly without the evolution of characteristic broad polymer backbone proton signals (FIGS. 16 and 17). This is consistent with the findings of Shimosaka et al. who first demonstrated the ability of NaSCN to act as an initiator and sensitizer during AN photopolymerization without any external source of initiating species.³⁹ As such, the formation of a weak charge transfer complex between AN and SCN provides suitable conditions in the system of the present invention to generate radicals on monomers through electron transfer induced rearrangement (FIG. 8).⁴⁰

By conducting reactions at equimolar ratios of acrylonitrile and NaSCN, the generation of radical species on acrylonitrile monomer results in bimolecular termination to form dimers rather than initiating polymerization as witnessed by Shimosaka et al. As a result, despite the ability to solubilize AN and PAN with 50 wt. % NaSCN, this UV-initiated electron transfer induced rearrangement significantly impeded molecular weight evolution.

The ultra-high molecular weight PAN polymers herein were achieved utilizing aqPI, which benefits from rapid propagation and high livingness ideal for achieving ultra-high molecular weight PAN. The aqPI polymerization approach of the present invention exhibited the fastest propagation rates and highest molecular weights reported for PAN while maintaining low dispersity. The spatiotemporal control of the polymerization along with the ability to polymerize di-blocks of PAN demonstrate the high degree of chain end fidelity maintained throughout the polymerization process, while providing a more environmentally friendly alternative using water when compared to traditional organic solvents currently used for the industrial synthesis of PAN pre-cursor polymer.

A UV-induced side reaction was observed during the polymerization of AN in the presence of the thiocyanate anion which significantly impeded molecular weight evolution, making this solution less than ideal for aqPI. Taken together, the approach of the present method controls PAN dispersity up to high molecular weights during aqPI in 60 wt. % ZnCl₂, which provides advantages when considering the downstream processing of PAN into carbon fiber, for example, lowering viscosity during the wet fiber spinning process, and enhancing mass retention through the carbonization process.

### Impact of Comonomer Incorporation and CTA Structure on the Thermo-Oxidative Stability of PAN-based Copolymers

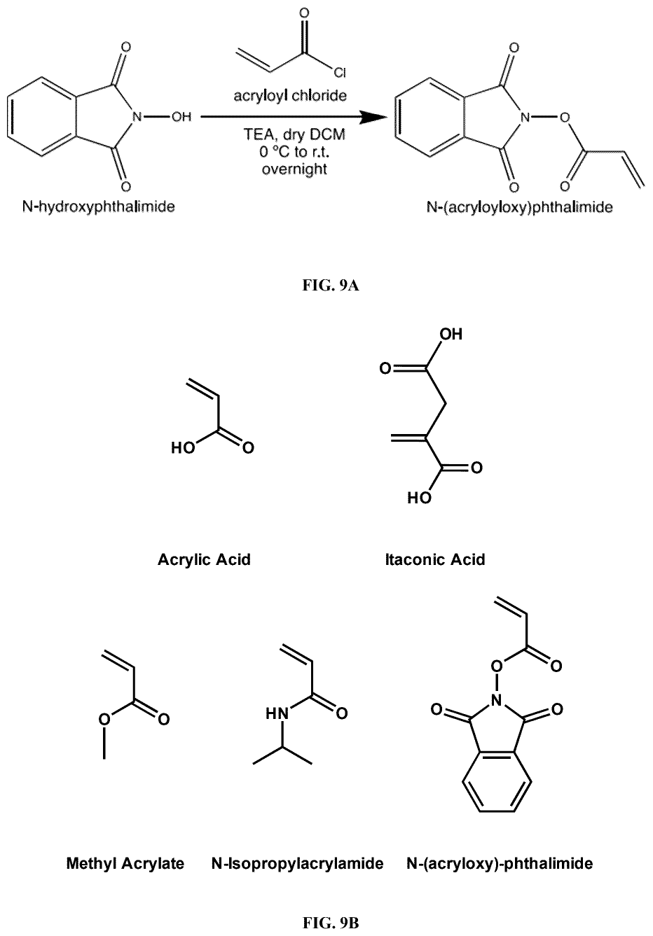

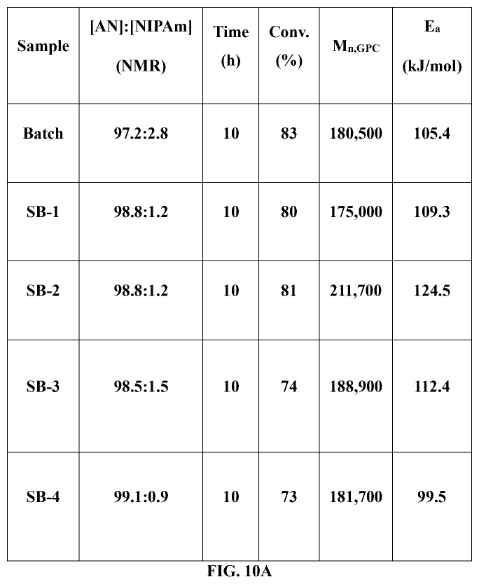

In a second aspect, the present invention relates to incorporating specific functional groups into the high molecular weight PANs of the present invention through copolymerization or CTA selection to enhance thermo-oxidative stabilization. The comonomers include acrylic acid and itaconic acid, which are both commonly used in commercial applications to support anionic ring closing processes; N-isopropylacrylamide, demonstrated to support anionic ring closing of PAN-based copolymers in academic research; and a phthalic anhydride vinyl monomer recently reported to initiate effective PAN ring closure through a radical process (FIG. 9).^{2, 41} PAN homopolymers exhibit a sharp, large exotherm at ˜260° C. during ring closure, driven by a spontaneous, radical mediated process. Previous research has focused on introducing nucleophilic monomers to initiate ring closing via an anionic process, which can lower the onset temperature and overall exotherm during ring closure, thus avoiding fiber defects such as voids. Deliberately incorporating phthalimide ester-based monomers to initiate a radical-mediated process at lower temperatures than those observed spontaneously for PAN can be used to enhance thermo-oxidative stability while preventing defects. Further, the bulk of the phthalimide ester-based monomer and N-isopropylacrylamide, should support plasticity of the PAN-based precursors improving processing and spinnability of the copolymer. The structure-property relationship of comonomer inclusion with controlled molecular weight of PAN-based polymers was determined.

Reactivity ratios may be determined experimentally based on the Kelen-Tudos, the Fineman-Ross, and the non-linear least squares (NLLS) methods for comparison as described previously.²¹ The polymers may be prepared with comonomer amounts of 1 wt. %, 2.5 wt. %, and 5 wt. % consistent with the literature on providing stabilization through these mechanisms.^{7, 18, 19, 42, 43} Depending on observed reactivity ratios in the aqueous media, a slow introduction of comonomer in a ‘semi-batch’ process may be employed to avoid compositional drift and encourage a uniform distribution of comonomer within the polymer chain. Molecular weights of 150,000 g-mol⁻¹ with dispersities below 1.2 were targeted to control the impact of molecular weight differences across samples. Copolymers of PAN were assessed for their ring closing cyclization efficiency by differential scanning calorimetry (DSC), by thermogravimetric analysis (TGA), and by Fourier transform infrared spectroscopy (FTIR) as described previously.²¹

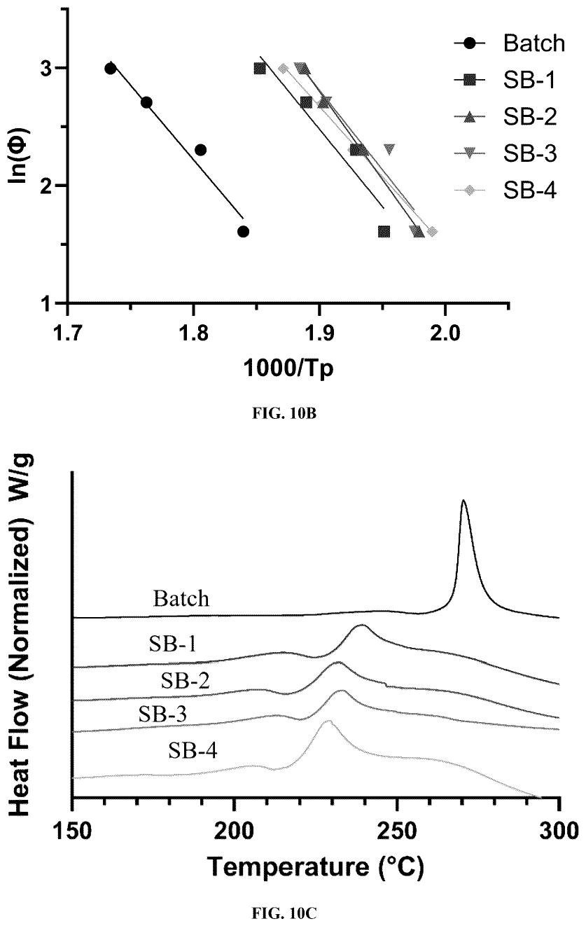

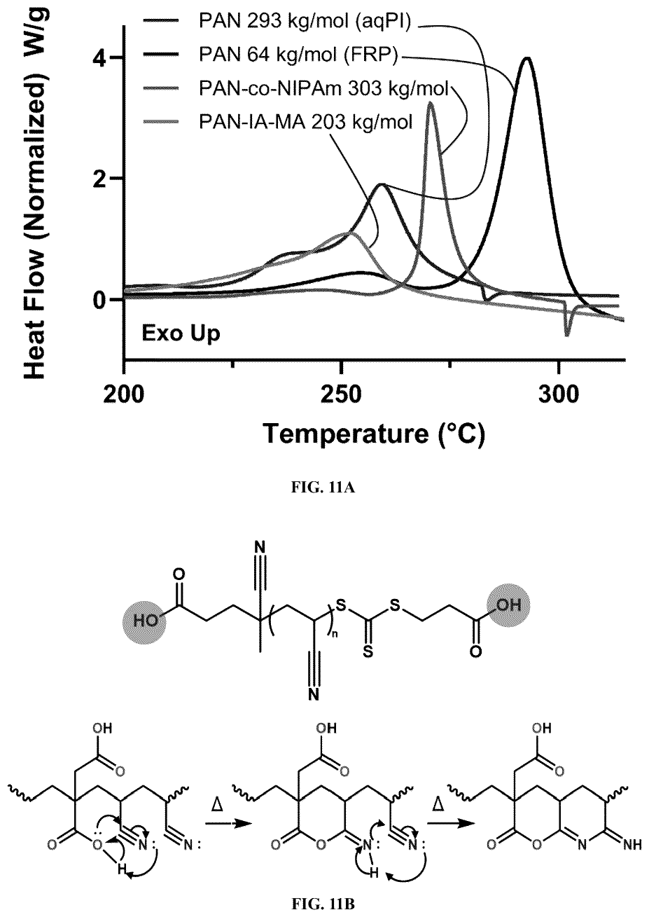

The semi-batch polymerizations yielded consistent monomer conversions (78.2±4.0%) within 10 hours. Importantly, thermal analysis indicated that the semi-batch photoiniferter approach offers advantages for PAN stabilization. Compared to conventional PAN, the semi-batch copolymers exhibited: (1) reduced exothermic heat release, (2) earlier onset of cyclization, and (3) broader temperature range for heat evolution. All formulations except SB-4 displayed increased activation energy (Ea), suggesting a higher energetic barrier to ionic cyclization at lower temperatures. This delayed onset reduces the risk of runaway exotherms and associated structural defects during stabilization. (FIG. 10C) Aside from the inclusion comonomers for ionic cyclization, thermal analysis of PAN synthesized by photo-iniferter polymerization displayed similar heat release profiles and remarkably high Ea. (FIG. 11A) While initially a surprising result, it highlights the ability of the carboxylic acid groups present on the CTA to participate in ring closure reactions, even at relatively low concentrations (FIG. 11B).

### Scale up Synthesis and White Fiber Spinning from Precursor Polymer Aqueous Dope-Spinning Solution

The polymers with comonomer incorporation may be used for scale up synthesis and wet fiber spinning. To achieve scale up, a custom built photoreactor capable of handling reactions of 2 L capacity was employed to achieve a final polymer yield of 250 g per sample. NMR and SEC-MALLS may be employed as described above to confirm polymer characteristics are unaltered through the increase in synthesis scale.

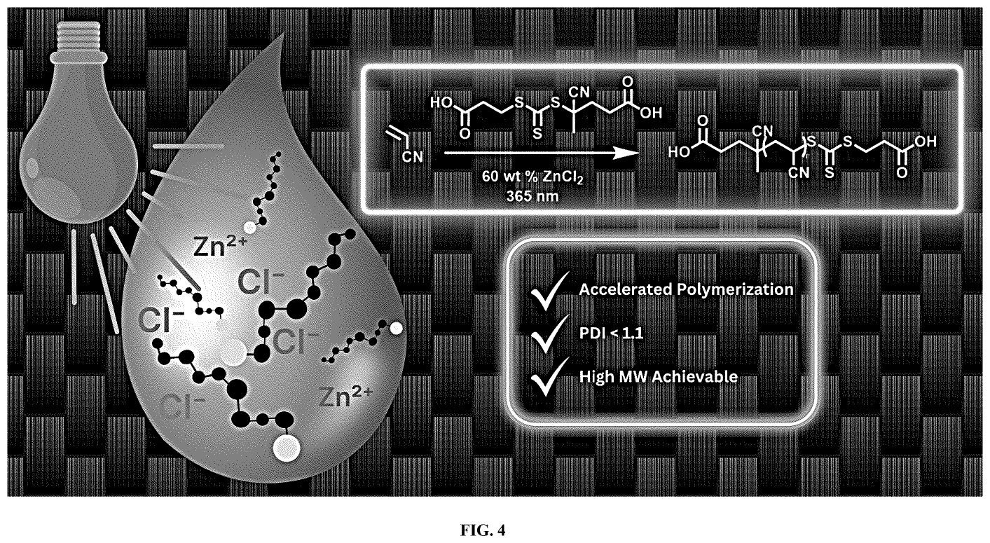

All fibers may be spun on a multifilament wet jet spinning line. Spinning of high molecular weight polymers, with high dispersity (such as those produced by free radical polymerization), is challenging due to their high viscosity and the difficulty of dissolving UHMW fractions. Rheological studies of spinning dope (i.e. the precursor polymer solution prior to spinning) containing high molecular weight RAFT-based precursors have shown reduced viscosities compared to traditional counterparts.^{16, 17} Through preliminary results (FIG. 4), and literature precedent of AqPI-RAFT,²⁷ the high molecular weight and low dispersity polymers are achievable at high monomer conversions. This provides an exciting opportunity to spin PAN-based precursor polymers directly from their aqueous synthesis medium without additional purification to remove unreacted monomer. An optimal dope viscosity for wet fiber spinning is typically 100 Pa*s to 200 Pa*s at a shear rate of 1 s⁻¹, for an aqueous polymer solution comprising 20 wt. % polymer at a spinning temperature of 50° C.¹⁷ Kinetic rheological assessments were carried out to confirm the target precursor polymer at high monomer conversion (>90%), within the rheological window considered optimal for wet fiber spinning.

Polyacrylonitrile (Mn=295 kg/mol), poly(acrylonitrile-co-N-isopropylacrylamide) (PAN-co-NIPAm, Mn=303 kg/mol), and poly(acrylonitrile-co-itaconic acid-co-methyl acrylate) (PAN-IA-MA, Mn=203 kg/mol) synthesized by Aq-PI polymerization were each dissolved in DMSO at concentrations of 15, 20, and 25% w/v to simulate the solution conditions relevant for wet-spinning. Frequency sweep rheology experiments were performed, with shear rates of 1 s−1 being comparable to that experienced during processing conditions. All polymer solutions exhibited spinnable viscosities at 20% w/v, with comonomer-containing systems supporting spinnable behavior at concentrations exceeding 25% w/v. (FIGS. 13A-13C). These findings are particularly noteworthy given that conventional industrial PAN precursors with comparable molecular weights (˜200 kg/mol) are typically limited to doping concentrations of 12-15% w/v due to viscosity constraints. This enhancement in spinnable doping concentration underscores the potential of photo-iniferter-derived PAN materials to meet and exceed current industrial processing standards, thereby advancing the design of high-performance carbon fiber precursors.

The fibers for spinning may be prepared from a lead formulation as both a crude dope and following standard protocols for purification and redissolution prior to spinning. These samples are compared to an AqPI-RAFT synthesized PAN homopolymer of matched molecular weight, and a commercially available PAN-based copolymer (i.e. Bluestar® PAN-based precursor).

### EXAMPLES

### Materials and Methods

### 1.1 Reagents

Acrylonitrile (AN, Acros Organics, >99%) and methyl acrylate (MA, Sigma Aldrich, >99%) were passed through a column of inhibitor removers and stored at 4° C. prior to polymerization. Zinc chloride (ZnCl₂, Sigma Aldrich, >98%), sodium thiocyanate (NaSCN, Sigma Aldrich, >98%), 4-((((2-carboxyethyl)thio)carbonothioyl)thio)-cyanopentanoic acid (CCPA, Boron Molecular, >99%), itaconic acid (IA, Sigma Aldrich, >99%), dimethyl sulfoxide (DMSO, Sigma Aldrich, >99%), N,N-dimethylformamide (DMF, Fisher Chemical, >99%), DMSO-d₆ (Millipore Sigma, >99%), and D₂O (TCI Chemicals, >98%) were used as received. Type II Milli-Q water (Millipore) was used in all experiments.

### 1.1.Aqueous Photo-iniferter Polymerization of Acrylonitrile—Inventive Example 1

20 mg of CCPA (0.065 mmol, 1 eq.), 1.73 g of acrylonitrile (32.5 mmol, 500 eq.), 5 mL of an aqueous solution of ZnCl₂ (60 wt. %) or NaSCN (50 wt. %), and 0.2 mL of DMF (NMR standard) were added to a 10 mL scintillation vial equipped with a stir bar and rubber septa followed by 30 minutes of degassing by bubbling nitrogen. Reactions were then exposed to UV light irradiation with magnetic stirring for 8 hours at 8° C. or 27° C. The polymer was isolated by precipitation of polymerization solution into excess deionized water and centrifuged. The precipitate was filtered, collected, and lyophilized overnight.

### 1.2. Aqueous Photo-Iniferter Polymerization of Acrylonitrile, Methyl Acrylate, and Itaconic Acid Inventive Example 2

237 mg of CCPA (0.771 mmol, 1 eq.), 250 g of acrylonitrile (4.71 mol, 6110 eq.), 12.9 g of methyl acrylate (150 mmol, 195 eq.), 19.6 g of itaconic acid (150 mmol, 195 eq.), 962 mL of an aqueous solution of ZnCl₂ (60 wt. %), and 2 mL of DMF (NMR standard) were added to a 2 L lyophilizer flask equipped with a stir bar and rubber septa followed by 60 minutes of degassing by bubbling nitrogen. Reactions were then exposed to UV light irradiation with magnetic stirring for 8 hours at 23° C. The polymer was isolated by coagulation of polymerization solution into excess deionized water and granulated. The precipitate was filtered, collected, and lyophilized overnight.

### 1.3. Semi-Batch Aqueous Photo-iniferter Polymerization of Acrylonitrile and N-isopropylacrylamide—Inventive Example 3

9.4 mg of CCPA (0.031 mmol, 1 eq.), 8.5 g of acrylonitrile (0.160 mol, 5225 eq.), 45.3 mL of an aqueous solution of ZnCl₂ (60 wt. %), and 0.5 mL of DMF (NMR standard) were added to a 250 mL 3-neck round bottom flask equipped with a stir bar and rubber septa followed by 30 minutes of degassing by bubbling nitrogen. In a separate scintillation vial, 0.954 g of N-isopropylacrylamide (8.43 mmol, 275 eq.) was dissolved in 6.36 mL of an aqueous solution of ZnCl₂ (60 wt. %) and degassed for 30 minutes by bubbling nitrogen before being drawn into a syringe. The polymerization vessel containing acrylonitrile was then exposed to UV light irradiation with magnetic stirring for 10 hours at 23° C., with the solution containing NIPAM being added dropwise to the polymerization media through a controlled syringe pump at a rate of 0.795 mL/hour. The polymer was isolated by coagulation of polymerization solution into excess deionized water and granulated. The precipitate was filtered, collected, and lyophilized overnight.

### 1.4.Photo-Iniferter Polymerization of Acrylonitrile in DMSO-Comparative Example 1

20 mg of CCPA (0.065 mmol, 1 equiv), 1.73 g of acrylonitrile (32.5 mmol, 500 equiv), 5 mL DMSO, and 0.2 mL of DMF (NMR standard) were added to a 10 mL scintillation vial equipped with a stir bar and rubber septa followed by 30 minutes of degassing by bubbling nitrogen. Reactions were then exposed to UV light irradiation with magnetic stirring for 8 hours at 27° C. The polymer was isolated by precipitation of polymerization solution into excess deionized water and centrifuged. The precipitate was filtered, collected, and lyophilized overnight.

### 1.5.Photo-Iniferter Polymerization of Acrylonitrile in Ethylene Carbonate Comparative Example 2

30 mg of CCPA (0.098 mmol, 1 eq.), 2.59 g of acrylonitrile (48.8 mmol, 500 eq.), 9.92 g of ethylene carbonate (0.113 mol), and 0.2 mL of DMF (NMR standard) were added to a 10 mL scintillation vial equipped with a stir bar and rubber septa followed by 30 minutes of degassing by bubbling nitrogen. Reactions were then exposed to UV light irradiation with magnetic stirring for 8 hours at 27° C. The polymer was isolated by precipitation of polymerization solution into excess deionized water and centrifuged. The precipitate was filtered, collected, and lyophilized overnight.

### 2. Characterization

### 2.1. Nuclear Magnetic Resonance (NMR) Spectroscopy

¹H and ¹³C NMR measurements were performed on a Bruker Avance 400 MHz or 600 MHz spectrometer in an appropriate solvent for the polymerization media (D₂O with 60 wt. % ZnCl₂, D₂O with 50 wt. % NaSCN, or DMSO-d₆). Acquired spectra were analyzed to quantify conversion of monomer (p), predicted molecular weights (M_{n,theor}), resulting molecular weights of isolated polymer (M_{n,NMR}), and tacticity of PAN homopolymer.

### 2.2. Gel Permeation Chromatography Multi-Angle Laser Light Scattering (GPC-MALLS)

The apparent molecular weights (M_{n,GPC}) and molecular weight distributions (M_{w}/Mₙ) were determined by gel permeation chromatography (GPC). The samples were lyophilized to remove water before dissolving 3-5 mg of polymer in 1 ml of DMAc with 0.5 M LiCl overnight at room temperature before measurement. Measurements were conducted on a Wyatt Technologies Viscotek GPC system equipped with I-MBHMW-3078 polar organic columns with DMAc containing 0.5 M LiCl as the eluent at a flow rate of 1 mL/min at 50° C. Apparent molecular weights were calculated according to the dn/dc value of PAN found in literature.¹

### 2.3. UV-Vis Spectroscopy

A typical ZnCl₂ polymerization mixture was irradiated with UV light for 24 hours, with aliquots taken at t=2, 4, 6, 8, and 24 hours. Reaction aliquots were diluted to a CTA concentration of 0.1 mg/mL and UV-Vis measurements were conducted on an Agilent BioTek Synergy H1 microplate reader. Measurements consisted of spectral scans across the range of 290 nm-450 nm with acquisitions in 2 nm increments. The degree of photolysis was determined by comparing the measured Aₘₐₓ at 310 nm, which is characteristic of trithiocarbonate.

### REFERENCES

(1) Moskowitz, J.; Wiggins, J. Thermo-oxidative stabilization of polyacrylonitrile and its copolymers: Effect of molecular weight, dispersity, and polymerization pathway. Polym Degrad Stabil 2016, 125, 76-86.
(2) Garrison, J. B.; Hughes, R. W.; Young, J. B.; Sumerlin, B. S. Photoinduced SET to access olefin-acrylate copolymers. Polym Chem-Uk 2022, 13 (7), 982-988. DOI: 10.1039/d1py01643a.
(3) Le, N. D.; Varley, R. J.; Hummel, M.; Trogen, M.; Byrne, N. A review of future directions in the development of sustainable carbon fiber from bio-based precursors. Mater Today Sustain 2022, 20. DOI: ARTN 10025110.1016/j.mtsust.2022.100251.
(4) Huang, X. S. Fabrication and Properties of Carbon Fibers. Materials 2009, 2 (4), 2369-2403. DOI: 10.3390/ma2042369.
(5) Global Carbon Fiber Reinforced Thermoplastic Composites (CFRTP) Market—Industry Trends and Forecast to 2030. Data Bridge Market Research, 2023. https://www.databridgemarketresearch.com/reports/global-cfrtp-market (accessed 6 Jan. 2024).
(6) Minus, M. L.; Kumar, S. The processing, properties, and structure of carbon fibers. Jom-Us 2005, 57 (2), 52-58. DOI: DOI 10.1007/s11837-005-0217-8.
(7) Chand, S. Carbon fibers for composites. J Mater Sci 2000, 35 (6), 1303-1313. DOI: Doi 10.1023/A: 1004780301489.
(8) Baker, D. A.; Rials, T. G. Recent advances in low-cost carbon fiber manufacture from lignin. J Appl Polym Sci 2013, 130 (2), 713-728. DOI: 10.1002/app.39273.
(9) Davey, S. G. Sweet new route to acrylonitrile. Nat Rev Chem 2018, 2 (1). DOI: 10.1038/s41570-017-0110.
(10) Kopec, M.; Krys, P.; Yuan, R.; Matyjaszewski, K. Aqueous RAFT Polymerization of Acrylonitrile. Macromolecules 2016, 49 (16), 5877-5883. DOI: 10.1021/acs.macromol.6b01336.
(11) Pan, X. C.; Lamson, M.; Yan, J. J.; Matyjaszewski, K. Photoinduced Metal-Free Atom Transfer Radical Polymerization of Acrylonitrile. Acs Macro Lett 2015, 4 (2), 192-196. DOI: 10.1021/mz500834g.
(12) Moskowitz, J. D.; Abel, B. A.; McCormick, C. L.; Wiggins, J. S. High Molecular Weight and Low Dispersity Polyacrylonitrile by Low Temperature RAFT Polymerization. J Polym Sci Pol Chem 2016, 54 (4), 553-562. DOI: 10.1002/pola.27806.
(13) Moskowitz, J. D.; Wiggins, J. S. Thermo-oxidative stabilization of polyacrylonitrile and its copolymers: Effect of molecular weight, dispersity, and polymerization pathway. Polym Degrad Stabil 2016, 125, 76-86. DOI: 10.1016/j.polymdegradstab.2015.12.025.
(14) Sayyar, S.; Moskowitz, J.; Fox, B.; Wiggins, J.; Wallace, G. Wet-spinning and carbonization of graphene/PAN-based fibers: Toward improving the properties of carbon fibers. J Appl Polym Sci 2019, 136 (36). DOI: ARTN 4793210.1002/app.47932.
(15) Li, J. J.; Ding, C. L.; Zhang, Z. B.; Zhu, J.; Zhu, X. L. Photo-induced reversible addition-fragmentation chain transfer (RAFT) polymerization of acrylonitrile at ambient temperature: A simple system to obtain high-molecular-weight polyacrylonitrile. React Funct Polym 2017, 113, 1-5. DOI: 10.1016/j.reactfunctpolym.2017.02.003.
(16) Cai, J. Y.; McDonnell, J.; Brackley, C.; O'Brien, L.; Church, J. S.; Millington, K.; Smith, S.; Phair-Sorensen, N. Polyacrylonitrile-based precursors and carbon fibers derived from advanced RAFT technology and conventional methods-The 1st comparative study. Mater Today Commun 2016, 9, 22-29. DOI: 10.1016/j.mtcomm.2016.09.001.
(17) Kaur, J.; Millington, K.; Cai, J. Y. Rheology of polyacrylonitrile-based precursor polymers produced from controlled (RAFT) and conventional polymerization: Its role in solution spinning. J Appl Polym Sci 2016, 133 (48). DOI: ARTN 4427310.1002/app.44273.
(18) Liu, H. C.; Luo, Q. H.; Zhang, S.; Shi, L. D.; Yang, J. L.; Liu, R. G.; Wang, M. L.; Zhu, C. Z.; Xu, J. New comonomer for polyacrylonitrile-based carbon fiber: Density functional theory study and experimental analysis. Polymer 2018, 153, 369-377. DOI: 10.1016/j.polymer.2018.08.041.
(19) Chen, Q. F.; He, B.; Chen, Y. T.; Zhu, H. Q.; Malik, H.; Wang, Y. H.; He, J.; Ma, B. M.; Wang, X. L.; Zhang, H.; et al. Terpolymers of acrylonitrile, methyl acrylate, and 2-acrylamido-2-methylpropane sulfonic acid for carbon fiber precursor: Effect of comonomers on the thermal stabilization of polyacrylonitrile copolymers. J Appl Polym Sci 2023, 140 (42). DOI: ARTN e5455210.1002/app.54552.
(20) Ju, A. Q.; Guang, S. Y.; Xu, H. Y. Effect of comonomer structure on the stabilization and spinnability of polyacrylonitrile copolymers. Carbon 2013, 54, 323-335. DOI: 10.1016/j.carbon.2012.11.044.
(21) Moskowitz, J. D.; Wiggins, J. S. Semibatch RAFT copolymerization of acrylonitrile and N-isopropylacrylamide: Effect of comonomer distribution on cyclization and thermal stability. Polymer 2016, 84, 311-318. DOI: 10.1016/j.polymer.2015.12.035.
(22) Wang, Y. S.; Xu, L. H.; Wang, M. Z.; Pang, W. M.; Ge, X. W. Structural Identification of Polyacrylonitrile during Thermal Treatment by Selective C-13 Labeling and Solid-State C-13 NMR Spectroscopy. Macromolecules 2014, 47 (12), 3901-3908. DOI: 10.1021/ma500727n.
(23) Li, N.; Ding, D. D.; Pan, X. Q.; Zhang, Z. B.; Zhu, J.; Boyer, C.; Zhu, X. L. Temperature programed photo-induced RAFT polymerization of stereo-block copolymers of poly(vinyl acetate). Polym Chem-Uk 2017, 8 (39), 6024-6027. DOI: 10.1039/c7py01531c.
(24) Sun, Y.; Fu, L. Y.; Olszewski, M.; Matyjaszewski, K. ATRP of N-Hydroxyethyl Acrylamide in the Presence of Lewis Acids: Control of Tacticity, Molecular Weight, and Architecture. Macromol Rapid Comm 2019, 40 (10). DOI: ARTN 180087710.1002/marc.201800877.
(25) Isobe, Y.; Fujioka, D.; Habaue, S.; Okamoto, Y. Efficient Lewis acid-catalyzed stereocontrolled radical polymerization of acrylamides. J Am Chem Soc 2001, 123 (29), 7180-7181. DOI: 10.1021/ja0158881.
(26) Jiang, J. G.; Lu, X. Y.; Lu, Y. Preparation of Polyacrylonitrile with Improved Isotacticity and Low Polydispersity. J Appl Polym Sci 2010, 116 (5), 2610-2616. DOI: 10.1002/app.31650.
(27) Carmean, R. N.; Becker, T. E.; Sims, M. B.; Sumerlin, B. S. Ultra-High Molecular Weights via Aqueous Reversible-Deactivation Radical Polymerization. Chem-Us 2017, 2 (1), 93-101. DOI: 10.1016/j.chempr.2016.12.007.
(28) Read, E.; Guinaudeau, A.; Wilson, D. J.; Cadix, A.; Violleau, F.; Destarac, M. Low temperature RAFT/MADIX gel polymerisation: access to controlled ultra-high molar mass polyacrylamides. Polym Chem-Uk 2014, 5 (7), 2202-2207. DOI: 10.1039/c3py01750h.
(29) Lowe, A. B.; McCormick, C. L. Aqueous RAFT polymerization: Recent developments in synthesis of functional water-soluble (Co) polymers with controlled structures. Accounts Chem Res 2004, 37 (5), 312-325. DOI: 10.1021/ar0302484.
(30) Lowe, A. B.; McCormick, C. L. Reversible addition-fragmentation chain transfer (RAFT) radical polymerization and the synthesis of water-soluble (co) polymers under homogeneous conditions in organic and aqueous media. Prog Polym Sci 2007, 32 (3), 283-351. DOI: 10.1016/j.progpolymsci.2006.11.003.
(31) Mahabadi, H. K.; O'Driscoll, K. F. Termination rate constant in free-radical polymerization. Journal of Polymer Science: Polymer Chemistry Edition 1977, 15 (2), 283-300.
(32) Iovleva, M. M.; Smirnova, V. N.; Budnitskii, G. A. The solubility of polyacrylonitrile. Fibre Chem+2001, 33 (4), 262-264. DOI: Doi 10.1023/A: 1012934313303.
(33) Morosoff, N.; Stannett, V. Some effects of small amounts of residual solvent on polyacrylonitrile film. Journal of Macromolecular Science, Part B 1980, 17 (1), 157-161. DOI: 10.1080/00222348008212805.
(34) Kim, D.; Moreno, N.; Nunes, S. P. Fabrication of polyacrylonitrile hollow fiber membranes from ionic liquid solutions. Polym Chem-Uk 2016, 7 (1), 113-124. DOI: 10.1039/c5py01344e.
(35) Serkov, A. T.; Budnitskii, G. A. Mechanism of polyacrylonitrile fibre spinning by the thiocyanate method. Fibre Chem+1994, 25 (5), 335-341. DOI: 10.1007/BF00551621.
(36) Nam, C. W.; Kim, Y. H.; Ko, S. W. Blend fibers of polyacrylonitrile and water-soluble chitosan derivative prepared from sodium thiocyanate solution. J Appl Polym Sci 2001, 82 (7), 1620-1629. DOI: DOI 10.1002/app.2001.
(37) Bajaj, P.; Roopanwal, A. K. Thermal stabilization of acrylic precursors for the production of carbon fibers: An overview. J Macromol Sci R M C 1997, (37 (1), 97-147.
(38) Kobayashi, S.; Nagayama, S.; Busujima, T. Lewis acid catalysts stable in water. Correlation between catalytic activity in water and hydrolysis constants and exchange rate constants for substitution of inner-sphere water ligands. J Am Chem Soc 1998, 120 (32), 8287-8288.
(39) Satoh, K.; Kamigaito, M. Stereospecific Living Radical Polymerization: Dual Control of Chain Length and Tacticity for Precision Polymer Synthesis. Chem Rev 2009, 109 (11), 5120-5156. DOI: 10.1021/cr900115u.
(40) Lu, L.; Zhang, H. J.; Yang, N. F.; Cai, Y. L. Toward rapid and well-controlled ambient temperature RAFT polymerization under UV-Vis radiation: Effect of radiation wave range. Macromolecules 2006, 39 (11), 3770-3776. DOI: 10.1021/ma060157x.
(41) Young, J. B.; Hughes, R. W.; Tamura, A. M.; Bailey, L. S.; Stewart, K. A.; Sumerlin, B. S. Bulk depolymerization of poly(methyl methacrylate) via chain-end initiation for catalyst-free reversion to monomer. Chem-Us 2023, 9 (9). DOI: 10.1016/j.chempr.2023.07.004.
(42) Wu, X. P.; Yang, Y. G.; Ling, L. C.; Li, Y. H.; He, F. Solution polymerization and thermal properties of acrylonitrile-acrylamide copolymer. New Carbon Mater 2003, 18 (3), 196-202.
(43) Frank, E.; Steudle, L. M.; Ingildeev, D.; Spörl, J. M.; Buchmeiser, M. R. Carbon Fibers: Precursor Systems, Processing, Structure, and Properties. Angew Chem Int Edit 2014, 53 (21), 5262-5298. DOI: 10.1002/anie.201306129.
(44) Kaur, J.; Millington, K.; Smith, S. Producing high-quality precursor polymer and fibers to achieve theoretical strength in carbon fibers: A review. J Appl Polym Sci 2016, 133 (38). DOI: Artn 4396310.1002/App.43963.
(45) McClelland, K. P.; Clemons, T. D.; Stupp, S. I.; Weiss, E. A. Semiconductor Quantum Dots Are Efficient and Recyclable Photocatalysts for Aqueous PET-RAFT Polymerization. ACS Macro Lett 2020, 9 (1), 7-13. DOI: 10.1021/acsmacrolett.9b00891.
(46) Sun, H.; Cao, W.; Zang, N. Z.; Clemons, T. D.; Scheutz, G. M.; Hu, Z. Y.; Thompson, M. P.; Liang, Y. F.; Vratsanos, M.; Zhou, X. H.; et al. Proapoptotic Peptide Brush Polymer Nanoparticles via Photoinitiated Polymerization-Induced Self-Assembly. Angew Chem Int Edit 2020, 59 (43), 19136-19142. DOI: 10.1002/anie.202006385.
(47) Fortenberry, A. W.; Jankoski, P. E.; Stacy, E. K.; McCormick, C. L.; Smith, A. E.; Clemons, T. D. A Perspective on the History and Current Opportunities of Aqueous RAFT Polymerization. Macromol Rapid Comm 2022. DOI: ARTN 220041410.1002/marc.202200414.
(47) Striegel, A. M. Specific Refractive Index Increment (∂n/∂n) of Polymers at 660 nm and 690 nm. Chromatographia 2017, 80 (6), 989-996. DOI: 10.1007/s10337-017-3294-2.

What is claimed is:

1. A polyacrylonitrile homopolymer, wherein the homopolymer has a number average molecular weight of from about 50,000 to about 1,000,000 g/mol, as measured by gel permeation chromatography, and a polydispersity index of from about 1.0 to about 1.5.

2. A method of making a polyacrylonitrile homopolymer, comprising mixing a)-c) to form a mixture:
a) an amount of an acrylonitrile monomer;
b) an amount of a chain transfer agent, and
c) an amount of an aqueous solution comprising one or more components selected from the group consisting of an inorganic salts, organic salts, transition metals, and one or more organic solvents; and
polymerizing the mixture via photo-iniferter reversible addition-fragmentation chain transfer (PI-RAFT) polymerization.

3. The method of claim 2, wherein the aqueous solution comprises the one or more inorganic salts selected from the group consisting of zinc salts and NaSCN, or combinations thereof.

4. The method of claim 2, wherein the homopolymer is polymerized in the mixture having a molar ratio of acrylonitrile monomer to chain transfer agent of from about 500:1 to about 50,000:1.

5. The method of claim 2, wherein the homopolymer is polymerized in the mixture having a molarity of the acrylonitrile monomer (mol) to the mixture (liter) of from about 0.5 mol/L to about 10 mol/L.

6. The method of claim 2, wherein the step of polymerizing is carried out for a period of 1 hour to about 120 hours.

7. The method of claim 2, where the aqueous solution comprises the inorganic salt, the organic salts, the transition metals, or the one or more organic solvents in an amount of from about 20 wt. % to about 80 wt. %, based on a total weight of the aqueous solution.

8. The method of claim 2, wherein the polymerization step is carried out at a temperature of from about −25° C.-80° C.

9. The method of claim 2, wherein the polymerization step comprises exposing the mixture to UV light irradiation.

10. The method of claim 2, wherein the chain transfer agent is 4-(((2-carboxyethyl)thio)carbonothioyl)thio)-cyanopentanoic acid (CCPA).

11. A polyacrylonitrile homopolymer composition formed by the method of claim 2.

12. A polymer formed by mixing a)-d) to form a mixture:
a) an amount of an acrylonitrile monomer;
b) an amount of a comonomer, wherein the comonomer is nucleophilic;
c) an amount of a chain transfer agent; and
d) an amount of an aqueous solution comprising one or more components selected from the group consisting of inorganic salts, organic salts, transition metals, and one or more organic solvents; and
polymerizing the mixture by photo-iniferter reversible addition-fragmentation chain transfer (PI-RAFT) polymerization to form the polymer.

13. The polymer of claim 12, wherein the comonomer is selected from the group consisting of phthalic anhydride vinyl, N-isopropylacrylamide, ethylenesulfonic acid, α-nitryl acrylic acid, α-amino acrylic acid, methyl acrylate, methyl methacrylate, acrylamide, acrylic acid, methacrylic acid, vinyl phosphoric acid, maleic anhydride, methacrylamide, 2-acrylamido-2-methyl-1-propane sulfonic acid, itaconic acid, N-isopropylacrylamide, N-vinyl formamide, N-phenylacrylateamide, N-(acryloyloxy)phthalimide, and 4-vinylphenylboronic acid.

14. A fiber comprising the polymer of claim 12.

15. A method of making a fiber, comprising spinning an aqueous solution comprising the polymer of claim 12, using a spinning process for forming the fiber.

16. The method of claim 15, wherein the aqueous polymer solution has a viscosity of from about 100 Pa·s to about 1000 Pa·s, at a shear rate of 1 s⁻¹ and a spinning temperature of 30-60° C., the aqueous polymer solution comprises 10 wt. % to 30 wt. % of the polymer, based on the total weight of the aqueous polymer solution, and the aqueous polymer solution comprises water, an organic polymer solution, a solvent, or combinations thereof.

17. The method of claim 16, wherein the organic polymer solution comprises dimethyl sulfoxide (DMSO), dimethylformamide (DMF), dimethylacetamide (DMAc), and/or ethylene carbonate (EC).

18. The method of claim 16, wherein the aqueous polymer solution has a viscosity of from about 100 Pa·s to about 200 Pa·s, at a shear rate of 1 s⁻¹ at a spinning temperature of 50° C., and the aqueous polymer solution comprises 20 wt. % of the polymer, based on the total weight of the aqueous polymer solution.

19. The method of claim 18, wherein the spinning is carried out with a multifilament wet jet spinning line.
